(19) United States
(12) Patent Application Publication
(10) Pub. No.: US 2025/0132871 A1
(43) Pub. Date: Apr. 24, 2025

(54) PREEMPTION TECHNIQUES FOR LOW LATENCY DEVICES

(71) Applicant: QUALCOMM Incorporated, San Diego, CA (US)

(72) Inventors: Sai Yiu Duncan HO, San Diego, CA (US); George CHERIAN, San Diego, CA (US); Abhishek Pramod PATIL, San Diego, CA (US); Alfred ASTERJADHI, San Diego, CA (US); Gaurang NAIK, San Diego, CA (US)

(21) Appl. No.: 18/506,563

(22) Filed: Nov. 10, 2023

Related U.S. Application Data
(60) Provisional application No. 63/591,340, filed on Oct. 18, 2023.

(51) Int. Cl. H04L 5/00; H04W 74/08

(52) U.S. Cl. CPC H04L 5/0044; H04W 74/08

(57) ABSTRACT

This disclosure provides methods, components, devices and systems for preemption techniques for low latency devices. Some aspects more specifically relate to preemption techniques to enable transmission of low latency data. In some examples, an access point (AP) may transmit a first physical layer protocol data unit (PPDU) using a dedicated resource unit (RU) and a broadcast RU. The broadcast RU may indicate information for a preemption indication, such as a resource unit within the same transmission opportunity (TXOP) for the preemption indication. A wireless station (STA) with pending low latency data may transmit the preemption indication via the RU indicated by the first PPDU. The preemption indication may indicate that a subsequent scheduled PPDU in the TXOP will be preempted for the STA to transmit a PPDU and convey the low latency data.

### CROSS REFERENCE

The present Application for Patent claims the benefit of U.S. Provisional Patent Application No. 63/591,340 by H O et al., entitled “PREEMPTION TECHNIQUES FOR LOW LATENCY DEVICES,” filed Oct. 18, 2023, assigned to the assignee hereof, and expressly incorporated by reference herein.

### TECHNICAL FIELD

This disclosure relates to wireless communication and, more specifically, to preemption techniques for low latency devices.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a transmission opportunity (TXOP) may be assigned to a device, for example, an AP or a STA. In some examples, one physical layer protocol data unit (PPDU) may be transmitted per TXOP. In such examples, if another device, such as a STA for an AP TXOP or the AP for a STA TXOP identifies low latency traffic for transmission, the other device waits until the end of the TXOP to transmit the low latency traffic, which may result in delay of low latency data or traffic.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless communication device. The method may include receiving, from a second wireless communication device, a first physical layer protocol data unit that indicates an allocation of a first resource unit (RU) for a preemption indication associated with low latency data, where the allocation of the first RU is within a transmission opportunity associated with the second wireless communication device, transmitting, via the first RU indicated by the first physical layer protocol data unit, the preemption indication associated with low latency data based on low latency data information at the first wireless communication device, where transmission of the preemption indication is after an end of the first physical layer protocol data unit and before a scheduled start time for a second physical layer protocol data unit from the second wireless communication device, and transmitting, based in accordance with the preemption indication, a third physical layer protocol data unit including the low latency data information, where the third physical layer protocol data unit preempts the second physical layer protocol data unit within the transmission opportunity.

Another innovative aspect of the subject matter described in this disclosure can be implemented in a first wireless communication device for wireless communications. The first wireless communication device may include a processing system that includes processor circuitry and memory circuitry that stores code. The processing system may be configured to cause the first wireless communication device to receive, from a second wireless communication device, a first physical layer protocol data unit that indicates an allocation of a first RU for a preemption indication associated with low latency data, where the allocation of the first RU is within a transmission opportunity associated with the second wireless communication device, transmit, via the first RU indicated by the first physical layer protocol data unit, the preemption indication associated with low latency data based on low latency data information at the first wireless communication device, where transmission of the preemption indication is after an end of the first physical layer protocol data unit and before a scheduled start time for a second physical layer protocol data unit from the second wireless communication device, and transmit, based in accordance with the preemption indication, a third physical layer protocol data unit including the low latency data information, where the third physical layer protocol data unit preempts the second physical layer protocol data unit within the transmission opportunity.

Another innovative aspect of the subject matter described in this disclosure can be implemented in a first wireless communication device for wireless communications. The first wireless communication device may include means for receiving, from a second wireless communication device, a first physical layer protocol data unit that indicates an allocation of a first RU for a preemption indication associated with low latency data, where the allocation of the first RU is within a transmission opportunity associated with the second wireless communication device, means for transmitting, via the first RU indicated by the first physical layer protocol data unit, the preemption indication associated with low latency data based on low latency data information at the first wireless communication device, where transmission of the preemption indication is after an end of the first physical layer protocol data unit and before a scheduled start time for a second physical layer protocol data unit from the second wireless communication device, and means for transmitting, based in accordance with the preemption indication, a third physical layer protocol data unit including the low latency data information, where the third physical layer protocol data unit preempts the second physical layer protocol data unit within the transmission opportunity.

Another innovative aspect of the subject matter described in this disclosure can be implemented in a non-transitory computer-readable medium storing code for wireless communications. The code may include instructions executable by one or more processors to receive, from a second wireless communication device, a first physical layer protocol data unit that indicates an allocation of a first RU for a preemption indication associated with low latency data, where the allocation of the first RU is within a transmission opportunity associated with the second wireless communication device, transmit, via the first RU indicated by the first physical layer protocol data unit, the preemption indication associated with low latency data based on low latency data information at the first wireless communication device, where transmission of the preemption indication is after an end of the first physical layer protocol data unit and before a scheduled start time for a second physical layer protocol data unit from the second wireless communication device, and transmit, based in accordance with the preemption indication, a third physical layer protocol data unit including the low latency data information, where the third physical layer protocol data unit preempts the second physical layer protocol data unit within the transmission opportunity.

Another innovative aspect of the subject matter described in this disclosure can be implemented in a method for wireless communications by a second wireless communication device. The method may include transmitting a first physical layer protocol data unit including a broadcast RU and one or more dedicated RUs, where a trigger frame transmitted via the broadcast RU indicates an allocation of a first RU for a preemption indication associated with low latency data, and where the allocation of the first RU is within a transmission opportunity associated with the second wireless communication device, receiving, from a first wireless communication device via the first RU indicated by the trigger frame, a preemption indication associated with low latency data, where reception of the preemption indication is after an end of the first physical layer protocol data unit and before a scheduled start time for a second physical layer protocol data unit from the second wireless communication device, and receiving, from the first wireless communication device and in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a second wireless communication device for wireless communications. The second wireless communication device may include a processing system that includes processor circuitry and memory circuitry that stores code. The processing system may be configured to cause the second wireless communication device to transmit a first physical layer protocol data unit including a broadcast RU and one or more dedicated RUs, where a trigger frame transmitted via the broadcast RU indicates an allocation of a first RU for a preemption indication associated with low latency data, and where the allocation of the first RU is within a transmission opportunity associated with the second wireless communication device, receive, from a first wireless communication device via the first RU indicated by the trigger frame, a preemption indication associated with low latency data, where reception of the preemption indication is after an end of the first physical layer protocol data unit and before a scheduled start time for a second physical layer protocol data unit from the second wireless communication device, and receive, from the first wireless communication device and in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a second wireless communication device for wireless communications. The second wireless communication device may include means for transmitting a first physical layer protocol data unit including a broadcast RU and one or more dedicated RUs, where a trigger frame transmitted via the broadcast RU indicates an allocation of a first RU for a preemption indication associated with low latency data, and where the allocation of the first RU is within a transmission opportunity associated with the second wireless communication device, means for receiving, from a first wireless communication device via the first RU indicated by the trigger frame, a preemption indication associated with low latency data, where reception of the preemption indication is after an end of the first physical layer protocol data unit and before a scheduled start time for a second physical layer protocol data unit from the second wireless communication device, and means for receiving, from the first wireless communication device and in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a non-transitory computer-readable medium storing code for wireless communications. The code may include instructions executable by a processor to transmit a first physical layer protocol data unit including a broadcast RU and one or more dedicated RUs, where a trigger frame transmitted via the broadcast RU indicates an allocation of a first RU for a preemption indication associated with low latency data, and where the allocation of the first RU is within a transmission opportunity associated with the second wireless communication device, receive, from a first wireless communication device via the first RU indicated by the trigger frame, a preemption indication associated with low latency data, where reception of the preemption indication is after an end of the first physical layer protocol data unit and before a scheduled start time for a second physical layer protocol data unit from the second wireless communication device, and receive, from the first wireless communication device and in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a method for wireless communications by a first wireless communication device. The method may include receiving, from a second wireless communication device, a first physical layer protocol data unit within a transmission opportunity associated with the second wireless communication device, transmitting a preemption indication associated with low latency data in an interframe space after an end time of a block acknowledgment to the first physical layer protocol data unit and before a scheduled start time for a second physical layer protocol data unit from the second wireless communication device based on a fixed size of the block acknowledgment to the first physical layer protocol data unit, and transmitting, in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a first wireless communication device for wireless communications. The first wireless communication device may include a processing system that includes processor circuitry and memory circuitry that stores code. The processing system may be configured to cause the first wireless communication device to receive, from a second wireless communication device, a first physical layer protocol data unit within a transmission opportunity associated with the second wireless communication device, transmit a preemption indication associated with low latency data in an interframe space after an end time of a block acknowledgment to the first physical layer protocol data unit and before a scheduled start time for a second physical layer protocol data unit from the second wireless communication device based on a fixed size of the block acknowledgment to the first physical layer protocol data unit, and transmit, in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a first wireless communication device for wireless communications. The first wireless communication device may include means for receiving, from a second wireless communication device, a first physical layer protocol data unit within a transmission opportunity associated with the second wireless communication device, means for transmitting a preemption indication associated with low latency data in an interframe space after an end time of a block acknowledgment to the first physical layer protocol data unit and before a scheduled start time for a second physical layer protocol data unit from the second wireless communication device based on a fixed size of the block acknowledgment to the first physical layer protocol data unit, and means for transmitting, in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a non-transitory computer-readable medium storing code for wireless communications. The code may include instructions executable by a processor to receive, from a second wireless communication device, a first physical layer protocol data unit within a transmission opportunity associated with the second wireless communication device, transmit a preemption indication associated with low latency data in an interframe space after an end time of a block acknowledgment to the first physical layer protocol data unit and before a scheduled start time for a second physical layer protocol data unit from the second wireless communication device based on a fixed size of the block acknowledgment to the first physical layer protocol data unit, and transmit, in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a method for wireless communications by a second wireless communication device. The method may include transmitting a first physical layer protocol data unit within a transmission opportunity associated with the second wireless communication device, receiving a block acknowledgment in response to the first physical layer protocol data unit, where the block acknowledgment has a fixed size, receiving, from a first wireless communication device, a preemption indication associated with low latency data in an interframe space after an end time of the block acknowledgment to the first physical layer protocol data unit and before a scheduled start time for a second physical layer protocol data unit from the second wireless communication device based on the fixed size of the block acknowledgment, and receiving, in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a second wireless communication device for wireless communications. The second wireless communication device may include a processing system that includes processor circuitry and memory circuitry that stores code. The processing system may be configured to cause the second wireless communication device to transmit a first physical layer protocol data unit within a transmission opportunity associated with the second wireless communication device, receive a block acknowledgment in response to the first physical layer protocol data unit, where the block acknowledgment has a fixed size, receive, from a first wireless communication device, a preemption indication associated with low latency data in an interframe space after an end time of the block acknowledgment to the first physical layer protocol data unit and before a scheduled start time for a second physical layer protocol data unit from the second wireless communication device based on the fixed size of the block acknowledgment, and receive, in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a second wireless communication device for wireless communications. The second wireless communication device may include means for transmitting a first physical layer protocol data unit within a transmission opportunity associated with the second wireless communication device, means for receiving a block acknowledgment in response to the first physical layer protocol data unit, where the block acknowledgment has a fixed size, means for receiving, from a first wireless communication device, a preemption indication associated with low latency data in an interframe space after an end time of the block acknowledgment to the first physical layer protocol data unit and before a scheduled start time for a second physical layer protocol data unit from the second wireless communication device based on the fixed size of the block acknowledgment, and means for receiving, in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a non-transitory computer-readable medium storing code for wireless communications. The code may include instructions executable by a processor to transmit a first physical layer protocol data unit within a transmission opportunity associated with the second wireless communication device, receive a block acknowledgment in response to the first physical layer protocol data unit, where the block acknowledgment has a fixed size, receive, from a first wireless communication device, a preemption indication associated with low latency data in an interframe space after an end time of the block acknowledgment to the first physical layer protocol data unit and before a scheduled start time for a second physical layer protocol data unit from the second wireless communication device based on the fixed size of the block acknowledgment, and receive, in accordance with the preemption indication, a third physical layer protocol data unit, where the third physical layer protocol data unit preempts the second physical layer protocol data unit within the transmission opportunity.

Another innovative aspect of the subject matter described in this disclosure can be implemented in a method for wireless communications by a first wireless communication device. The method may include transmitting, to a second wireless communication device, a first physical layer protocol data unit within a transmission opportunity associated with the first wireless communication device, where the first physical layer protocol data unit includes an indication that preemption for low latency data is enabled and receiving an acknowledgment in response to the first physical layer protocol data unit, where the acknowledgment includes a preemption indication associated with low latency data based on the indication that preemption for low latency data is enabled.

Another innovative aspect of the subject matter described in this disclosure can be implemented in a first wireless communication device for wireless communications. The first wireless communication device may include a processing system that includes processor circuitry and memory circuitry that stores code. The processing system may be configured to cause the first wireless communication device to transmit, to a second wireless communication device, a first physical layer protocol data unit within a transmission opportunity associated with the first wireless communication device, where the first physical layer protocol data unit includes an indication that preemption for low latency data is enabled and receive an acknowledgment in response to the first physical layer protocol data unit, where the acknowledgment includes a preemption indication associated with low latency data based on the indication that preemption for low latency data is enabled.

Another innovative aspect of the subject matter described in this disclosure can be implemented in a first wireless communication device for wireless communications. The first wireless communication device may include means for transmitting, to a second wireless communication device, a first physical layer protocol data unit within a transmission opportunity associated with the first wireless communication device, where the first physical layer protocol data unit includes an indication that preemption for low latency data is enabled and means for receiving an acknowledgment in response to the first physical layer protocol data unit, where the acknowledgment includes a preemption indication associated with low latency data based on the indication that preemption for low latency data is enabled.

Another innovative aspect of the subject matter described in this disclosure can be implemented in a non-transitory computer-readable medium storing code for wireless communications. The code may include instructions executable by one or more processors to transmit, to a second wireless communication device, a first physical layer protocol data unit within a transmission opportunity associated with the first wireless communication device, where the first physical layer protocol data unit includes an indication that preemption for low latency data is enabled and receive an acknowledgment in response to the first physical layer protocol data unit, where the acknowledgment includes a preemption indication associated with low latency data based on the indication that preemption for low latency data is enabled.

Another innovative aspect of the subject matter described in this disclosure can be implemented in a method for wireless communications by a second wireless communication device. The method may include receiving, from a first wireless communication device, a first physical layer protocol data unit within a transmission opportunity associated with the first wireless communication device, where the first physical layer protocol data unit includes an indication that preemption for low latency data is enabled, transmitting an acknowledgment in response to the first physical layer protocol data unit, where the acknowledgment includes a preemption indication associated with low latency data based on the indication that preemption for low latency data is enabled, and transmitting, in accordance with the preemption indication, a second physical layer protocol data unit within the transmission opportunity associated with the first wireless communication device.

Another innovative aspect of the subject matter described in this disclosure can be implemented in a second wireless communication device for wireless communications. The second wireless communication device may include a processing system that includes processor circuitry and memory circuitry that stores code. The processing system may be configured to cause the second wireless communication device to receive, from a first wireless communication device, a first physical layer protocol data unit within a transmission opportunity associated with the first wireless communication device, where the first physical layer protocol data unit includes an indication that preemption for low latency data is enabled, transmit an acknowledgment in response to the first physical layer protocol data unit, where the acknowledgment includes a preemption indication associated with low latency data based on the indication that preemption for low latency data is enabled, and transmit, in accordance with the preemption indication, a second physical layer protocol data unit within the transmission opportunity associated with the first wireless communication device.

Another innovative aspect of the subject matter described in this disclosure can be implemented in a second wireless communication device for wireless communications. The second wireless communication device may include means for receiving, from a first wireless communication device, a first physical layer protocol data unit within a transmission opportunity associated with the first wireless communication device, where the first physical layer protocol data unit includes an indication that preemption for low latency data is enabled, means for transmitting an acknowledgment in response to the first physical layer protocol data unit, where the acknowledgment includes a preemption indication associated with low latency data based on the indication that preemption for low latency data is enabled, and means for transmitting, in accordance with the preemption indication, a second physical layer protocol data unit within the transmission opportunity associated with the first wireless communication device.

Another innovative aspect of the subject matter described in this disclosure can be implemented in a non-transitory computer-readable medium storing code for wireless communications. The code may include instructions executable by one or more processors to receive, from a first wireless communication device, a first physical layer protocol data unit within a transmission opportunity associated with the first wireless communication device, where the first physical layer protocol data unit includes an indication that preemption for low latency data is enabled, transmit an acknowledgment in response to the first physical layer protocol data unit, where the acknowledgment includes a preemption indication associated with low latency data based on the indication that preemption for low latency data is enabled, and transmit, in accordance with the preemption indication, a second physical layer protocol data unit within the transmission opportunity associated with the first wireless communication device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIGS. 5 through 7 show a transmission opportunity (TXOP) timing diagram that supports preemption techniques for low latency devices.

FIG. 8 shows a process flow that supports preemption techniques for low latency devices.

FIG. 9 shows a block diagram of an example wireless communication device that supports preemption techniques for low latency devices.

FIG. 10 shows a block diagram of an example wireless communication device that supports preemption techniques for low latency devices.

FIG. 11 shows a flowchart illustrating an example process performable by or at a first wireless communication device that supports preemption techniques for low latency devices.

FIG. 12 shows a flowchart illustrating an example process performable by or at a second wireless communication device that supports preemption techniques for low latency devices.

FIG. 13 shows a flowchart illustrating an example process performable by or at a first wireless communication device that supports preemption techniques for low latency devices.

FIG. 14 shows a flowchart illustrating an example process performable by or at a second wireless communication device that supports preemption techniques for low latency devices.

FIG. 15 shows a flowchart illustrating an example process performable by or at a first wireless communication device that supports preemption techniques for low latency devices.

FIG. 16 shows a flowchart illustrating an example process performable by or at a second wireless communication device that supports preemption techniques for low latency devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to preempting existing transmission opportunities (TXOPs) such that devices with low latency traffic to transmit may access the communication medium during the TXOP to transmit the low latency traffic. Some aspects more specifically relate to using relatively short physical layer protocol data units (PPDUs) within TXOPs with interframe spaces between the PPDUs such that a device with low latency traffic to transmit may transmit a preemption indication during the interframe space. Short PPDUs may refer to PPDUs in scenarios where multiple PPDUs are scheduled in a single TXOP. In some examples, a first wireless communication device, such as an ultra-high reliability (UHR) wireless station (STA), may identify low latency traffic during a first PPDU of a TXOP assigned to a second wireless communication device, such as an access point (AP). The second wireless communication device may transmit the first PPDU using a dedicated resource unit (RU) to transmit information to a third wireless device and using a broadcast RU to indicate information for a preemption indication. For example, the first PPDU may indicate a RU for the preemption indication. The first wireless communication device may transmit the preemption indication via the RU indicated by the first PPDU. The preemption indication may indicate that a subsequent scheduled PPDU in the TXOP will be preempted to allow the first wireless communication device to transmit a PPDU and convey the low latency traffic. In some examples, the first PPDU may indicate that preemption of the second PPDU is allowed (such as in a PHY header or a receiver address for the preemption indication). In some examples, an AP may transmit a preemption indication to a STA, and the AP may use a remaining duration of a TXOP to transmit downlink low latency traffic.

Particular aspects of the subject matter described in this disclosure can be implemented to realize one or more of the following potential advantages. In some examples, by using short PPDUs within a TXOP, the described techniques can allow other devices to preempt other transmissions within the TXOP to transmit low latency traffic. Allowing preemption of a TXOP in order to transmit low latency traffic can reduce the time to transmit the low latency data, and thus may improve latency. The holder of the TXOP may be unaware that another device has low latency traffic to transmit, and thus a preemption indication may enable a device to indicate that the device have low latency traffic to transmit in order to preempt a PPDU from the TXOP holder. The TXOP holder may accordingly delay or postpone transmission of less urgent traffic that would have been transmitted in the preempted PPDU. By indicating the RU for the preemption indication via a broadcast RU in the first PPDU, any STA supporting low latency communications may identify the RU to transmit the preemption indication, which may prevent some STAs, such as hidden STAs or hidden nodes, from transmitting the preemption indication based on other triggers, such as an end of an acknowledgment to the first PPDU.

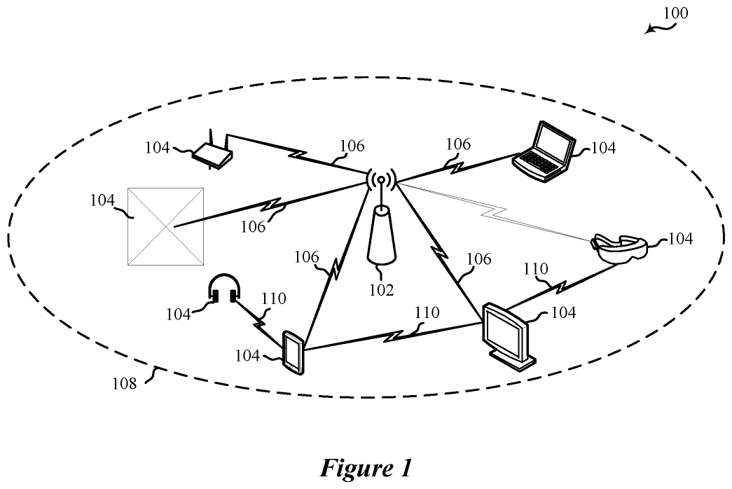

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106. STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low latency requirements, or may provide lossless audio to one or more other devices. For example, the AP 102 or the STAs 104 may support applications and use cases associated with ultra-low latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n. 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-QAM, where a modulated symbol carries 10 bits. To further improve peak data rate, each of the AP 102 or the STA 104 may employ use of 4096-QAM (also referred to as “4 k QAM”), which enables a modulated symbol to carry 12 bits. 4 k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 us per OFDM symbol). The AP 102 or the STA 104 using 4096-QAM may enable a 20% increase in data rate compared to 1024-QAM given the same coding rate, thereby allowing users to obtain higher transmission efficiency.

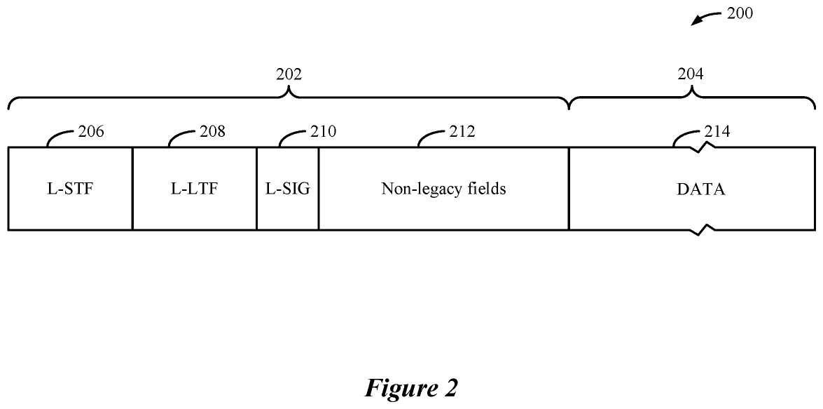

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

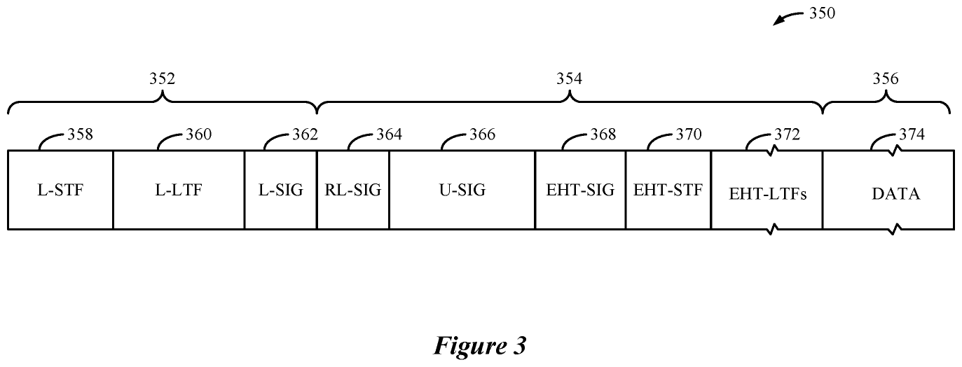

FIG. 3 shows an example PHY PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include RU allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

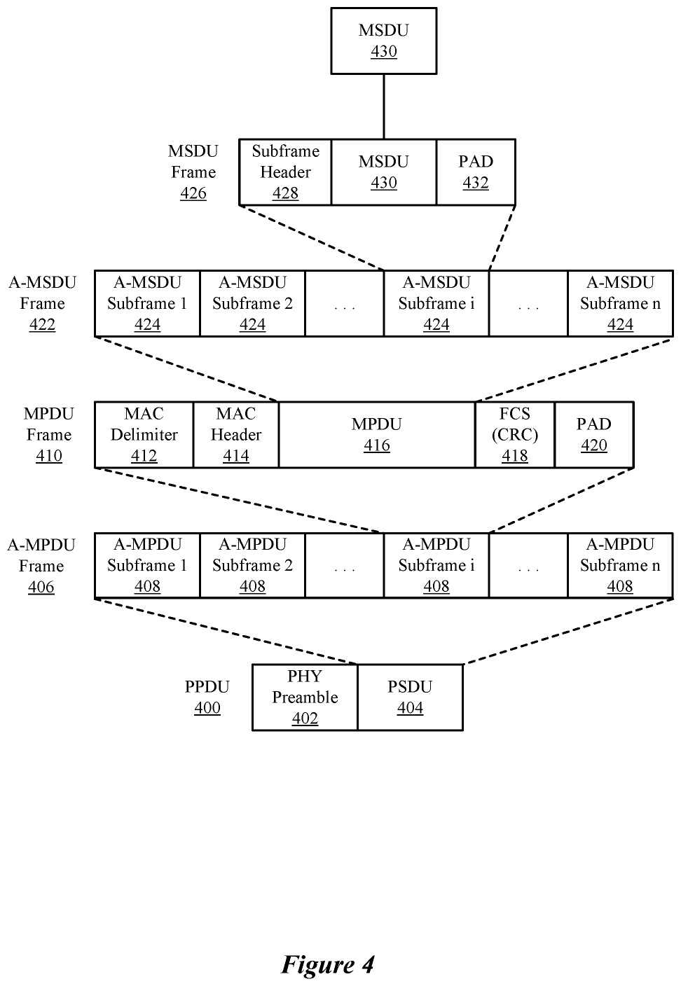

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 may be associated with (such as an example of or otherwise referred to as) an MSDU frame 426 and may contain a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a NAV, which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of wireless communication network 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low latency data traffic will gain access to a shared wireless medium during a given contention period, unpredictable outcomes of medium access contention operations may prevent low latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or RUs associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of the wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

Some wireless devices, such as STAs 104 and APs 102 may implement UHR. UHR may include low latency channel access enhancements to improve latency for event driven traffic use cases. Two potential enhancement scenarios include preemption within a TXOP for downlink event-driven and/or aperiodic low latency traffic and preemption within a TXOP for uplink event-driven and/or aperiodic low latency traffic. For event-driven low latency data, a STA 104 with low latency event-driven traffic may not be the TXOP holder or responder, and therefore such a STA 104 waits for the current TXOP holder to finish its transmissions. For low latency event-driven uplink traffic, the AP 102 does not know which non-AP STA 104 has such low-latency traffic in its queue and what is the size of such low-latency traffic.

STAs 104 and APs 102 may use techniques described herein to preempt TXOPs in order to transmit low latency traffic. For example, TXOPs may be scheduled with interframe spaces between the PPDUs such that a device with low latency traffic to transmit may transmit a preemption indication during the interframe space. Low latency traffic also may be referred to as latency sensitive traffic. In some examples, a first wireless communication device, such as a UHR STA 104 or an AP 102 may identify low latency traffic during a first PPDU of a TXOP assigned to a second wireless communication device. In some examples, an AP 102 may transmit a downlink PPDU including a broadcast RU and one or more dedicated RUs. The broadcast RU may indicate an allocation of an RU for the preemption indication, and a STA 104 with low latency traffic may transmit a preemption indication on the indicated RU. In some examples, the first wireless communication device may transmit a preemption indication in an interframe space (such as a PIFS or a SIFS) that indicates that a subsequent scheduled PPDU in the TXOP will be preempted for the first wireless communication device to transmit a PPDU to convey the low latency traffic.

In some examples, allocating an RU for the preemption indication may prevent one or more STAs 104 from missing an opportunity to transmit the preemption indication. For example, if the STAs 104 are to transmit the preemption indication in an inter-frame space after an acknowledgment to the first PPDU, STAs 104 which do not hear or receive the acknowledgment may not be aware of when the acknowledgment ends. For example, the acknowledgment signaling to a STA 104 with pending low latency data with may be blocked, such as by an AP 102 or an obstruction. The STA 104 may not be aware of the size of the acknowledgment to the first PPDU, and the STA 104 may not transmit the preemption indication.

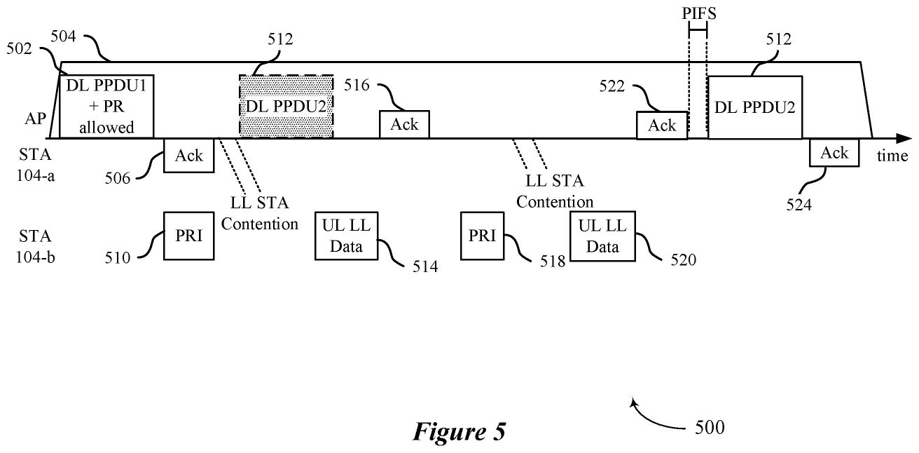

FIG. 5 shows a TXOP timing diagram 500 that supports low latency channel access. The TXOP timing diagram 500 may implement or may be implemented by aspects of the wireless communication network 100.

The TXOP timing diagram 500 shows an example where a STA 104 transmits a preemption indication using a RU indicated by a downlink PPDU. For example, FIG. 5 illustrates that the AP 102 may transmit a first downlink PPDU 502 that includes an indication that preemption within the TXOP 504 is allowed (labeled as “DL PPDU+PR allowed” in FIG. 5). Some aspects described with reference to FIG. 5 may similarly be implemented in scenarios where a STA 104 transmits a preemption indication after an acknowledgment with a fixed size. Additionally, or alternatively, some aspects described with reference to FIG. 5 may be similarly implemented in scenarios where an AP 102 transmits a preemption indication to a STA 104, and the STA 104 defers at least a portion of the TXOP to the AP 102 such that the AP 102 may transmit downlink low latency traffic.

The AP 102 may transmit the first downlink PPDU 502 using a broadcast RU and one or more dedicated RUs. For example, the AP 102 may transmit information or frames to a STA 104-a using the one or more dedicated RUs. In some examples the first downlink PPDU 502 may be a MU PPDU with a single broadcast RU and one or more dedicated RUs, where the broadcast RU is for one or more STAs and a dedicated RU is for an associated STA. In some examples, the STA 104-a may be an example of an intended STA 104, or a STA 104 for which the frames transmitted via the one or more dedicated RUs are intended. In some examples, the frames transmitted via the one or more dedicated RUs may indicate an RU for the STA 104-a to transmit an acknowledgment 506 to the first downlink PPDU 502. For example, the AP 102 may allocate, via the dedicated RU of the first downlink PPDU 502, a RU for the STA 104-a to send an acknowledgment as a response to the information in the first downlink PPDU 502 for the STA 104-a, and the STA 104-a may transmit the acknowledgment 506 via the RU indicated by the dedicated RU of the first downlink PPDU 502. In some examples, the RU for the acknowledgment 506 may be indicated via a triggered response scheduling (TRS) control field in a MAC header of a frame or via a trigger frame aggregated with other frames for, or intended for, the STA 104-a. In some examples, the AP 102 may transmit multiple dedicated RUs directed to multiple different STAs 104, and each dedicated RU may carry a TRS field or trigger field to indicate a corresponding RU for a respective STA 104 to transmit an acknowledgment.

A broadcast RU of the first downlink PPDU 502 may indicate information for a preemption indication 510. For example, the broadcast RU may carry a trigger frame that includes or indicates an RU for preemption indications. In some examples, the broadcast RU may carry a trigger frame containing random access RU (RA-RU) for soliciting a preemption indication response. In some examples, the RU for the preemption indication may be identified by an association identifier (AID) in the trigger frame (for example, of the broadcast RU). In some examples, an RU for a preemption indication may be associated with a dedicated AID. For example, in a trigger frame, the RU may be identified based on an AID value, and the AID value may be defined (e.g., define a new AID value from a pool of currently reserved values) for soliciting preemption indication. In some examples, the RU for preemption indications may be interpretable or decodable by STAs 104 that support UHR, low latency communications, or both. For example, a STA 104 which does not support UHR or low latency communications may not decode or identify the RU for preemption indications. The STA 104-b may support UHR and low latency communications, and the STA 104-b may decode the broadcast RU of the first downlink PPDU 502. In some examples, the STA 104-b may decode the broadcast RU based on a wireless station identifier of, or indicated by, the broadcast resource unit. In some examples, the STA 104-b may decode the first downlink PPDU 502 or the broadcast RU of the first downlink PPDU 502 in accordance with an AID associated with low latency data, UHR, or preemption indication. In some examples, a value of the AID may be defined or dedicated for responding to PRI.

In some examples, the broadcast RU of the first downlink PPDU 502 may indicate multiple RUs for preemption indications for multiple types of traffic. For example, the broadcast RU of the first downlink PPDU 502 may indicate a first RU for a preemption indication for low latency traffic, and the broadcast RU of the first downlink PPDU 502 may indicate a second RU for a preemption indication for a second type of traffic. In some examples, the broadcast RU may indicate a traffic identifier (TID), an access category (AC), or a stream classification service (SCS) identifier associated with each RU allocated for a preemption indication. In some cases, the RUs may be prioritized, split, or both, based on SCS traffic streams.

In some examples, the first downlink PPDU 502 may include multiple broadcast RUs, each broadcast RU identified by a respective AID value (e.g., a specific AID value), and each broadcast RU of the multiple broadcast RUs may solicit a preemption indication for a different type of traffic or traffic category (e.g., PRI for a specific traffic category). In some examples, each broadcast RU of the multiple broadcast RUs may include a trigger frame indicating an RU for a preemption indication for the respective type of traffic. In an example, each broadcast RU may carry a single trigger frame carrying a single RA-RU for PRI.

The STA 104-b may transmit a preemption indication 510 via the RU indicated by the broadcast RU of the first downlink PPDU 502. For example, the STA 104-b may determine that the STA 104-b has low latency traffic to transmit while the AP 102 has control of the channel. The STA 104-b may transmit the preemption indication 510 based on having low latency traffic.

In some examples, the STA 104-b may not perform a channel contention procedure or perform a countdown in order to transmit the preemption indication 510. For example, a STA 104 may transmit a preemption indication in the TXOP 504 without performing a listen before talk (LBT) procedure. In some examples, a non-AP device, such as a STA 104, may maintain an RU counter (e.g., a random access RU counter) and decrement the RU counter by a quantity of RUs assigned in a trigger frame. If, after decrementing, the RU counter is 0 or lower, the STA 104 may select one of the RUs for transmission (e.g., select an RA-RU). If, however, the STA 104 is assigned an RU for a preemption indication, the STA 104 may use the assigned RU for the preemption indication regardless of the RU counter. For example, the STA 104-b may not perform a countdown for the RU counter based on a quantity of RUs assigned in the trigger frame, and the STA 104-b may be able to transmit the preemption indication on the RU assigned by the trigger frame without performing the countdown.

In some examples, multiple STAs 104 may have low latency traffic during the TXOP 504, and the multiple STAs 104 may each transmit a preemption indication 510. In some examples, each of the multiple STAs 104 may receive the broadcast RU of the first downlink PPDU 502 and transmit the preemption indication 510 on the RU for the preemption indication indicated by the broadcast RU (e.g., the RA-RU assigned for sending the PRI response).

In some examples, each of the preemption indications may carry the same information or be identical. For example, the STA 104-a and another STA 104 may each have pending low latency data, and both STAs 104 may transmit a same preemption indication 510 on the RU indicated by the broadcast RU. In some examples, the AP's trigger frame, containing RA-RU, carries information for any responding low latency STAs to construct a PPDU (e.g., the preemption indication 510) that is identical. In some implementations, the preemption indication 510 may be a signaling frame, such as a clear to send (CTS) frame. If a CTS frame is used for the preemption indication 510, the contents of each CTS frame from different STAs 104 may be identical. For example, each CTS frame may have a same service field. In some examples, a scrambler for a CTS frame may be copied from a trigger frame soliciting the preemption indication (such as the trigger frame in the broadcast RU). In some examples, STAs 104 may generate a CTS frame for a preemption indication 510 by using a common reference, such as bits of an FCS field of the trigger frame. In some examples, a value for the scrambler for the CTS frame or preemption indication 510 may be predefined or preconfigured at STAs 104 which support UHR or low latency communications, or both. In some examples, the preemption indication 510 may be a PPDU. For example, the preemption indication 510 may be a PPDU (e.g., a transport block (TB) PPDU) which carries null A-MPDU delimiters.

The preemption indication(s) 510 may preempt a second downlink PPDU 512 (labeled as “DL PPDU2” in FIG. 5). The AP 102 may drop (such as refrain from transmitting) the second downlink PPDU 512 in response to receiving the preemption indication(s) 510. The STAs 104 that transmit preemption indications 510 may contend (labeled as “LL STA Contention” in FIG. 5) to send low latency uplink data. A STA 104 that succeeds in the contention may transmit a first uplink PPDU 514 (e.g., a single user (SU) PPDU) that includes uplink low latency data (labeled as “UL LL Data” in FIG. 5). The AP 102 may transmit an acknowledgment 516 to reception of the first uplink PPDU 514.

In some examples, the acknowledgment 516 may include an indication that preemption within the TXOP 504 is allowed. STA(s) 104 that receive the acknowledgment 516 that indicates preemption is allowed and that have uplink low latency data to transmit may transmit a preemption indication 518 after the acknowledgment 516. In some examples, STA(s) 104 with low latency traffic may send the preemption indication 518 a SIFs after the acknowledgment 516. The STAs 104 that transmit preemption indications 518 may contend to send low latency uplink data. A STA 104 that succeeds in the contention may transmit a second uplink PPDU 520 that includes uplink low latency data labeled as “UL LL Data” in FIG. 5). The AP 104 may transmit an acknowledgment 522 to reception of the second uplink PPDU 520.

In some examples, the AP 102 may transmit the second downlink PPDU 512 after transmitting the acknowledgment 522. For example, the acknowledgment 522 may not indicate that preemption is allowed. In some examples, the acknowledgment 522 may indicate that preemption is allowed, but the AP 102 does not receive any preemption indications. The AP 102 may access the channel after transmitting the acknowledgment 522 and transmit the second downlink PPDU 512 if the TXOP 504 is not expired. In some examples, the AP 102 may access the channel a PIFS after transmitting the acknowledgment 522. In some examples, the second downlink PPDU 512 may be sent to the STA 104-a, and the STA 104-a may transmit an acknowledgment 524 responsive to the second downlink PPDU 512.

In some examples, an AP 102 or a STA 104 may set a NAV during the TXOP 504. For example, the AP 102 may set an intra-BSS NAV for in-BSS STAs 104 and an inter-BSS NAV for other devices. In some examples, the first downlink PPDU 502 may set an overall NAV so other BSSs or STAs within the BSS are silent (e.g., do not transmit during the NAV time period). In some examples, the contention period to transmit low latency uplink data, such as the first uplink PPDU 514, may be longer than PIFS, which may allow another device to sense the medium as free and jump on the medium. To protect medium, the STA 104-b may have an intra-BSS NAV and may access the channel with a shorter countdown than another AP 102 with an inter-BSS NAV, which may provide a higher likelihood of a STA 104 with low latency data, such as the STA 104-b, accessing the channel and transmitting the low latency data before another communication device accesses the channel. Using these techniques, OBSS STAs may be blocked due to the inter-BSS NAV, in-BSS STAs may be blocked and may wait for service from their AP, and LL STAs may ignore the NAV and attempt to secure the medium when having low latency data to transmit. This technique may be used with a contention-free end (CF-end) frame to indicate when other STAs are permitted to contend for the medium.

In some examples, wireless communication devices may incrementally set a NAV. For example, the first downlink PPDU 502 may set a first NAV. In some examples, the STA 104-b may ignore the NAV to transmit the preemption indication 510. The STA 104-b may transmit the first uplink PPDU 514, which may set a second NAV.

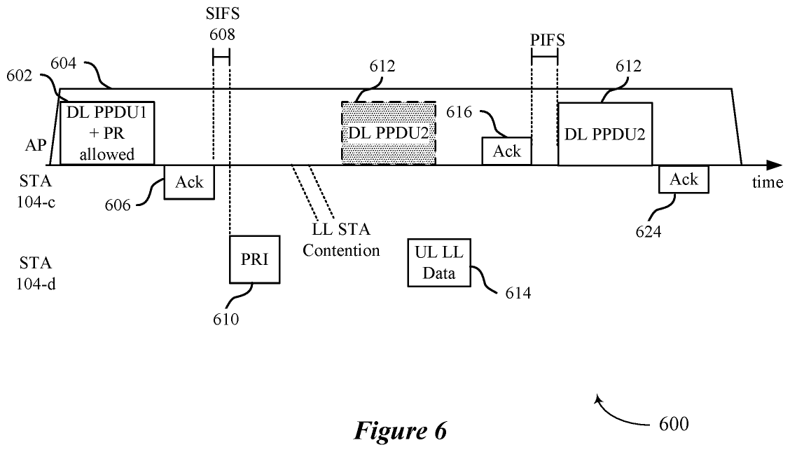

FIG. 6 shows a TXOP timing diagram 600 that supports low latency channel access. The TXOP timing diagram 600 may implement or may be implemented by aspects of the wireless communication network 100

The TXOP timing diagram 600 shows an example where a STA 104 transmits a preemption indication 610 after an acknowledgment 606 from another STA 104. For example, FIG. 6 illustrates that the AP 102 may transmit a first downlink PPDU 602 that includes an indication that preemption within the TXOP 604 is allowed (labeled as “DL PPDU+PR allowed” in FIG. 6).

The AP 102 may transmit the first downlink PPDU 602 including information or frames for a STA 104-c, in some examples using one or more dedicated RUs. In some examples, the STA 104-c may be an example of an intended STA 104, or a STA 104 for which the frames transmitted via the one or more dedicated RUs are intended. The STA 104-c may transmit the acknowledgment 606 for the first downlink PPDU 602.

In some examples, the STA 104-c may be an example of a UHR STA 104. The STA 104-c may transmit the acknowledgment 606 with a fixed length. For example, based on the first downlink PPDU 602 including a preemption request, the STA 104-c may transmit the acknowledgment 606 (e.g., a block acknowledgment) having a fixed length. For example, the first downlink PPDU 602 may include up to a threshold quantity of aggregated MPDUs, such that a bitmap (such as a feedback bitmap) in the acknowledgment 606 has a fixed length. In some examples, the STA 104-c may pad the frame of the acknowledgment 606 such that the acknowledgment 606 is the fixed length, such as if the first downlink PPDU 602 includes fewer aggregated MPDUs.

The STA 104-d may transmit a preemption indication 610 a SIFS 608 after the acknowledgment 606. For example, the STA 104-d may determine that the STA 104-d has low latency traffic to transmit while the AP 102 has control of the channel. The STA 104-d may transmit the preemption indication 610 based on having low latency traffic. In some examples, the STA 104-d may not perform a channel contention procedure in order to transmit the preemption indication 610. For example, a STA 104 may transmit a preemption indication in the TXOP 604 without performing an LBT procedure or an RU countdown.

In some examples, multiple STAs 104 may have low latency traffic during the TXOP 604, and the multiple STAs 104 may each transmit a preemption indication 610. In some examples, each of the multiple STAs 104 may transmit the preemption indication 610 at the same time based on the duration of the first downlink PPDU 602, the duration of the SIFS 608, and the duration of the acknowledgment 606 with the fixed size. For example, all low latency STAs 104 that see the first downlink PPDU 502 having a preemption request (such as in a header of the first downlink PPDU 502) may know when to transmit the preemption indication 610, due to the acknowledgment 606 having a fixed size (e.g., duration of the DL PPDU+SIFS_1+BA (fixed length)+SIFS_2=start time of preemption indication 610, where SIFS_1 occurs between the first downlink PPDU 602 and the acknowledgment 606 and SIFS_2 occurs between the acknowledgment 606 and the preemption indication 610). In some examples, each of the preemption indications may carry the same information or be identical. For example, the STA 104-d and another STA 104 may each have pending low latency data, and both STAs 104 may transmit a preemption indication 610 with the same content or information at the same time. The preemption indication 610 may be, for example, a signaling frame, a CTA frame, or a PPDU with null A-MPDU delimiters.

The preemption indications 610 may preempt a second downlink PPDU 612 (labeled as “DL PPDU2” in FIG. 6). The AP 102 may drop (such as refrain from transmitting) the second downlink PPDU 612 in response to receiving the preemption indications 610. The STAs 104 that transmit preemption indications 610 may contend (labeled as “LL STA Contention” in FIG. 6) to send low latency uplink data. A STA 104 that succeeds in the contention may transmit a first uplink PPDU 614 that includes uplink low latency data (labeled as “UL LL Data” in FIG. 6). The AP 102 may transmit an acknowledgment 616 to reception of the first uplink PPDU 614.

In some examples, the AP 102 may transmit the second downlink PPDU 612 after transmitting the acknowledgment 616. For example, the acknowledgment 616 may not indicate that preemption is allowed. In some examples, the acknowledgment 616 may indicate that preemption is allowed, but the AP 102 does not receive any preemption indications. The AP 102 may access the channel after transmitting the acknowledgment 616 and transmit the second downlink PPDU 612 if the TXOP 604 is not expired. In some examples, the AP 102 may access the channel a PIFS after transmitting the acknowledgment 616. In some examples, the second downlink PPDU 612 may be sent to the STA 104-a, and the STA 104-a may transmit an acknowledgment 624 responsive to the second downlink PPDU 512. In some examples, the acknowledgment 616 may include an indication that preemption within the TXOP 504 is allowed to enable STAs 104 to transmit additional low latency uplink data.

In some examples, an AP 102 or a STA 104 may set a NAV during the TXOP 604. For example, the AP 102 may set an intra-BSS NAV for in-BSS STAs 104 and an inter-BSS NAV for other devices. Additionally, or alternatively, the wireless communication devices may incrementally set a NAV. In some cases where the duration of the acknowledgment 606 is variable, the TXOP Duration of the soliciting PPDU (e.g., the first downlink PPDU 602) in a single TXOP protection setting may advertise a duration of the acknowledgment 606 information to surrounding nodes, so that the surrounding nodes may know when to transmit the preemption indication 610.

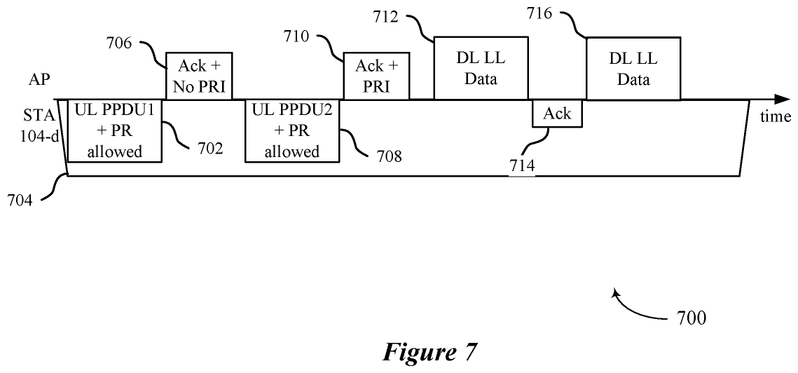

FIG. 7 shows a TXOP timing diagram 700 that supports low latency channel access. The TXOP timing diagram 700 may implement or may be implemented by aspects of the wireless communication network 100.

The TXOP timing diagram 700 shows an example where a STA 104-d is associated with a TXOP 704, and an AP 102 takes over the transmission opportunity to transmit low latency data information. For example, FIG. 7 illustrates that the STA 104-d may transmit a first uplink PPDU 702 that includes an indication that preemption within the TXOP 704 is allowed (labeled as “UL PPDU1+PR allowed” in FIG. 7).

The AP 102 may transmit feedback, such as an acknowledgment 706, for the first uplink PPDU 702. In some examples, the acknowledgment 706 may include an indication, or be transmitted with an indication, that the AP 102 does not have downlink low latency data or pending downlink low latency data. In some examples, the AP 102 may indicate, via a multi-user block acknowledgment (MBA) or enhanced MBA (eMBA), that the AP 102 does not have downlink low latency data. In some examples, the acknowledgment 706 may not include a preemption indicator. In some examples, the acknowledgment 706 may include an indication that the acknowledgment 706 does not include a preemption indicator.

The STA 104-d may transmit a second uplink PPDU 708 that includes an indication that preemption within the TXOP is allowed (labeled as “UL PPDU2+PR allowed” in FIG. 7. For example, a longer uplink PPDU may be split into smaller PPDUs, including the first uplink PPDU 702 and the second uplink PPDU 708.

The AP 102 may transmit feedback, such as an acknowledgment 710, for the second uplink PPDU 708. The acknowledgment 710 may include an indication that the AP 102 does have downlink low latency data or pending downlink low latency data. For example, the AP 102 may indicate a preemption indication through the acknowledgment 710. In some examples, the acknowledgment 710 may include the preemption indication.

In some examples, the STA 104-d may relinquish or defer the rest of the TXOP 704 to the AP 102 based on the preemption indication. For example, the STA 104-d may receive the acknowledgment 710 and may relinquish the remainder of the TXOP 704 to the AP 102 such that the AP 102 may transmit the downlink low latency data.

The AP 102 may transmit downlink low latency data 712 (labeled as “DL LL Data” in FIG. 7) in accordance with the preemption indication. The AP 102 may receive, in response to the downlink low latency data 712, an acknowledgment 714. In some examples, the AP 102 may transmit the downlink low latency data 712 to the STA 104-d. For example, the STA 104-d may transmit the acknowledgment 714 to the AP 102. In some examples, the AP 102 may preempt the uplink transmissions of the STA 104-d to transmit downlink low latency information to other STAs 102. For example, the AP 102 may transmit downlink low latency data 716 to another STA 102. In some examples, the AP 102 may transmit downlink low latency data to one or more STAs 104 after gaining control of the transmission opportunity, where the STA 104 originally associated with the transmission opportunity may or may not be a recipient of the downlink low latency data.

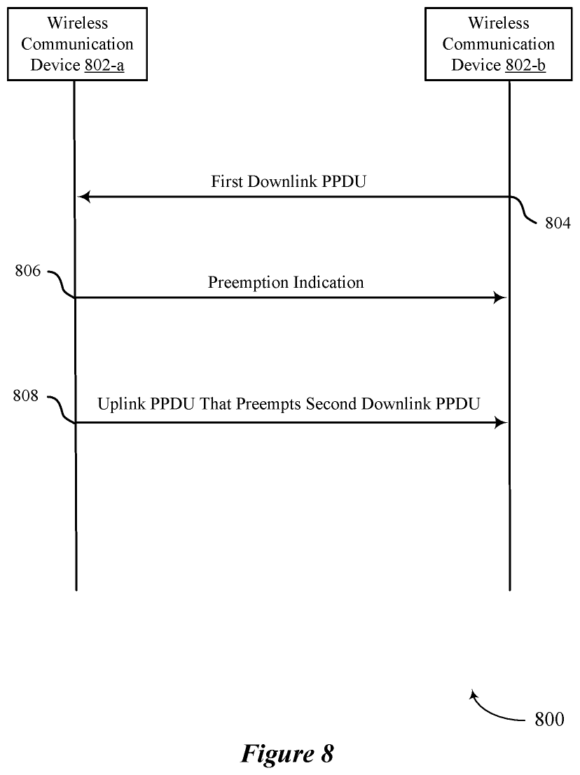

FIG. 8 shows an example of a process flow 800 that supports low latency channel access. The process flow 800 includes a first wireless communication device 802-a and a second wireless communication device 802-b, which may be examples of APs 102 or STAs 104 as described herein. In the following description of the process flow 800, the operations between the first wireless communication device 802-a and the second wireless communication device 802-b may be transmitted in a different order than the example order shown, or the operations performed by the first wireless communication device 802-a and the second wireless communication device 802-b may be performed in different orders or at different times. Some operations also may be omitted from the process flow 800, and other operations may be added to the process flow 800.

At 804, the second wireless communication device 802-b may transmit a first downlink PPDU. For example, the first wireless communication device 802-a may receive, from the second wireless communication device 802-b, a first PPDU that indicates an allocation of a first RU for a preemption indication associated with low latency data. The allocation of the first RU may be within a TXOP associated with the second wireless device.

In some examples, first downlink PPDU may include, or be transmitted using, a broadcast RU and one or more dedicated RUs. For example, the first wireless communication device 802-a may receive, via the broadcast RU, a trigger frame that indicates the allocation of the first RU for the preemption indication associated with low latency data. In some examples, the first wireless communication device 802-a may receive the first downlink PPDU and determine that the one or more dedicated RUs are not addressed to the first wireless communication device 802-a, and the first wireless communication device 802-a may decode signaling on the broadcast RU.

In some examples, the first wireless communication device 802-a may decode signaling on the broadcast RU of the first PPDU based on a wireless station identifier of the broadcast RU. In some examples, the first wireless communication device 802-a may decode the first PPDU based on an association identifier of the first PPDU associated with low latency data.

In some examples, the first PPDU may indicate RUs for preemption indications for different types of traffic. For example, the first PPDU may indicate a second allocation of a second RU for a second preemption indication associated with a second type of traffic. The first PPDU may include or indicate a traffic identifier, an access category, or a stream classification service identifier for the second type of traffic.

At 806, the first wireless communication device 802-a may transmit a preemption indication associated with low latency data. For example, the first wireless communication device 802-a may transmit, via the first RU indicated by the first PPDU, the preemption indication associated with low latency data based on low latency data information at the first wireless communication device 802-a. In some examples, the first wireless communication device 802-a may transmit the preemption indication after an end of the first PPDU and before a scheduled start time for a second PPDU from the second wireless communication device.

In some examples, the first wireless communication device 802-a may transmit a signaling frame including the preemption indication. In some examples, the first wireless communication device 802-a may transmit a trigger-based PPDU including null A-MPDU delimiters as the preemption indication. In some examples, a CTS frame may be an example of the preemption indication.

In some examples, the second wireless communication device 802-b may receive multiple preemption indications from different wireless communication devices. For example, the second wireless communication device 802-b may receive multiple preemption indications associated with low latency data. In some examples, each preemption indication of the multiple preemption indications may include a same content or same information. In some examples, wireless communications devices that transmit preemption indications may generate the preemption indications using a same set of information, which may be preconfigured or indicated by the first PPDU.

At 808, the first wireless communication device 802-a may transmit, in accordance with the preemption indication, a third PPDU including the low latency data information. In some examples, the third PPDU may preempt the second PPDU from the second wireless communication device 802-b within the TXOP.

In some examples, the first wireless communication device 802-a may transmit the preemption indication based on a fixed size of an acknowledgment to the first PPDU. For example, at 804, the first wireless communication device 802-a may receive, from the second wireless communication device 802-b, the first PPDU within a TXOP associated with the second wireless communication device 802-b. At 806, the first wireless communication device 802-a may transmit a preemption indication associated with low latency data in an interframe space after an end time of a block acknowledgment to the first PPDU and before a scheduled start time for a second PPDU from the second wireless communication device 802-b based on a fixed size of the block acknowledgment to the first PPDU. At 808, the first wireless communication device 802-a may transmit, in accordance with the preemption indication, a third PPDU, where the third PPDU preempts the second PPDU within the TXOP.

In some examples, similar techniques may be implemented for downlink low latency data. For example, a STA 104 may gain access to a transmission opportunity and transmit an uplink PPDU to an AP 102. The uplink PPDU may indicate that preemption is allowed. An AP 102 may transmit an acknowledgment to the uplink PPDU and may indicate or include a preemption indication with the acknowledgment. The STA 104 may relinquish the remainder of the transmission opportunity to the AP 102, and the AP 102 may transmit downlink low latency data to one or more STAs 104.

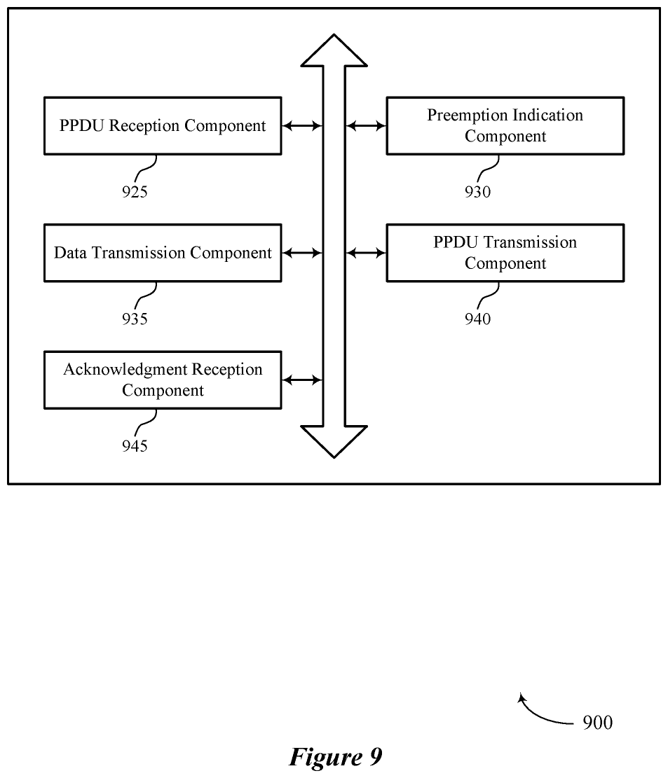

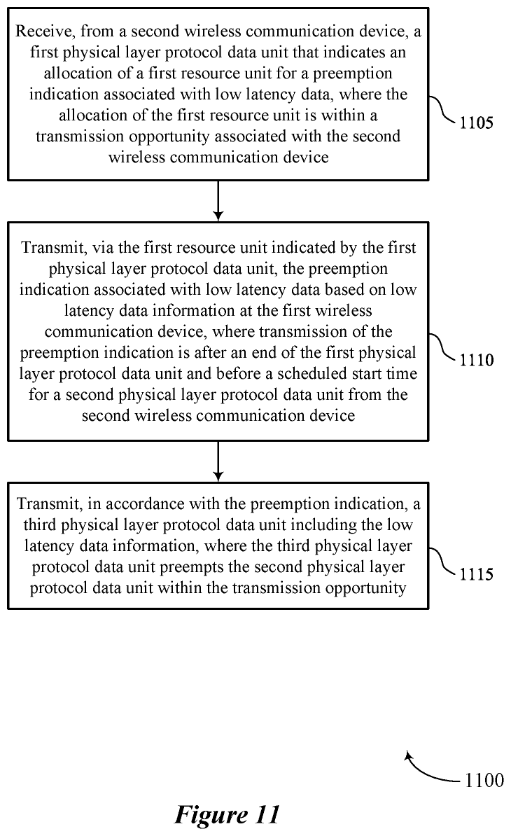

FIG. 9 shows a block diagram of an example wireless communication device 900 that supports preemption techniques for low latency devices. In some examples, the wireless communication device 900 is configured to perform the processes 1100, 1300, and 1500 described with reference to FIGS. 11, 13, and 15, respectively. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can configurable or configured for use in a STA, such as the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system.

The wireless communication device 900 includes a PPDU reception component 925, a preemption indication component 930, a data transmission component 935, a PPDU transmission component 940, and an acknowledgment reception component 945. Portions of one or more of the PPDU reception component 925, the preemption indication component 930, the data transmission component 935, the PPDU transmission component 940, and the acknowledgment reception component 945 may be implemented at least in part in hardware or firmware. For example, one or more of the PPDU reception component 925, the preemption indication component 930, the data transmission component 935, the PPDU transmission component 940, and the acknowledgment reception component 945 may be implemented at least in part by at least a processor or a modem. In some examples, portions of one or more of the PPDU reception component 925, the preemption indication component 930, the data transmission component 935, the PPDU transmission component 940, and the acknowledgment reception component 945 may be implemented at least in part by a processor and software in the form of processor-executable code stored in memory.

The wireless communication device 900 may support wireless communications in accordance with examples as disclosed herein. The PPDU reception component 925 is configurable or configured to receive, from a second wireless communication device, a first PPDU that indicates an allocation of a first RU for a preemption indication associated with low latency data, where the allocation of the first RU is within a TXOP associated with the second wireless communication device. The preemption indication component 930 is configurable or configured to transmit, via the first RU indicated by the first PPDU, the preemption indication associated with low latency data based on low latency data information at the first wireless communication device, where transmission of the preemption indication is after an end of the first PPDU and before a scheduled start time for a second PPDU from the second wireless communication device. The data transmission component 935 is configurable or configured to transmit, in accordance with the preemption indication, a third PPDU including the low latency data information, where the third PPDU preempts the second PPDU within the TXOP.

In some examples, to support receiving the first PPDU, the PPDU reception component 925 is configurable or configured to receive, via a broadcast RU, a trigger frame that indicates the allocation of the first RU for the preemption indication associated with low latency data, where the first PPDU includes the broadcast RU and one or more dedicated RUs.

In some examples, the PPDU reception component 925 is configurable or configured to decode signaling on the broadcast RU of the first PPDU based on a wireless station identifier of the broadcast RU.

In some examples, the PPDU reception component 925 is configurable or configured to decode the first PPDU based on an association identifier associated with low latency data.

In some examples, to support transmitting the preemption indication, the preemption indication component 930 is configurable or configured to transmit a signaling frame including the preemption indication, where transmitting the third PPDU is based on transmitting the signaling frame.

In some examples, to support transmitting the preemption indication, the preemption indication component 930 is configurable or configured to transmit a trigger-based PPDU including null aggregate MAC protocol data unit delimiters, where transmitting the third PPDU is based on the trigger-based PPDU.

In some examples, the preemption indication component 930 is configurable or configured to generate the preemption indication based on information indicated by the first PPDU.

In some examples, the first PPDU set a first NAV for a first set of wireless communication devices including at least the first wireless communication device, and the third PPDU sets a second NAV for a second set of wireless communication devices that are not associated with low latency data.

In some examples, the first PPDU sets a first NAV, and the preemption indication component 930 is configurable or configured to set a second NAV based on transmission of the third PPDU.

In some examples, the first PPDU indicate a second allocation of a second RU for a second preemption indication associated with a second type of traffic. In some examples, the first PPDU include a traffic identifier, an access category, or a stream classification service identifier for the second type of traffic.

In some examples, the first RU be a random access RU.

In some examples, the random access RU be associated with a traffic category.

In some examples, to support transmitting the preemption indication, the preemption indication component 930 is configurable or configured to transmit the preemption indication without performing an RU countdown, an LBT procedure, or a channel access countdown, or any combination thereof.

Additionally, or alternatively, the wireless communication device 900 may support wireless communications in accordance with examples as disclosed herein. In some examples, the PPDU reception component 925 is configurable or configured to receive, from a second wireless communication device, a first PPDU within a TXOP associated with the second wireless communication device. In some examples, the preemption indication component 930 is configurable or configured to transmit a preemption indication associated with low latency data in an interframe space after an end time of a block acknowledgment to the first PPDU and before a scheduled start time for a second PPDU from the second wireless communication device based on a fixed size of the block acknowledgment to the first PPDU. In some examples, the data transmission component 935 is configurable or configured to transmit, in accordance with the preemption indication, a third PPDU, where the third PPDU preempts the second PPDU within the TXOP.

Additionally, or alternatively, the wireless communication device 900 may support wireless communications in accordance with examples as disclosed herein. The PPDU transmission component 940 is configurable or configured to transmit, to a second wireless communication device, a first physical layer protocol data unit within a transmission opportunity associated with the first wireless communication device, where the first physical layer protocol data unit includes an indication that preemption for low latency data is enabled. The acknowledgment reception component 945 is configurable or configured to receive an acknowledgment in response to the first physical layer protocol data unit, where the acknowledgment includes a preemption indication associated with low latency data based on the indication that preemption for low latency data is enabled.

In some examples, the PPDU transmission component 940 is configurable or configured to transmit, to the second wireless communication device, a third physical layer protocol data unit within the transmission opportunity associated with the first wireless communication device, where the third physical layer protocol data unit includes a second indication that preemption for low latency data is enabled. In some examples, the acknowledgment reception component 945 is configurable or configured to receive a second acknowledgment in response to the third physical layer protocol data unit, where the second acknowledgment includes an indication that the second wireless communication device does not have low latency data.

In some examples, the PPDU reception component 925 is configurable or configured to receive, in accordance with the preemption indication, a second physical layer protocol data unit from the second wireless communication device within the transmission opportunity associated with the first wireless communication device.

In some examples, the acknowledgment reception component 945 is configurable or configured to defer a remainder of the transmission opportunity associated with the first wireless communication device to the second wireless communication device in accordance with the preemption indication.

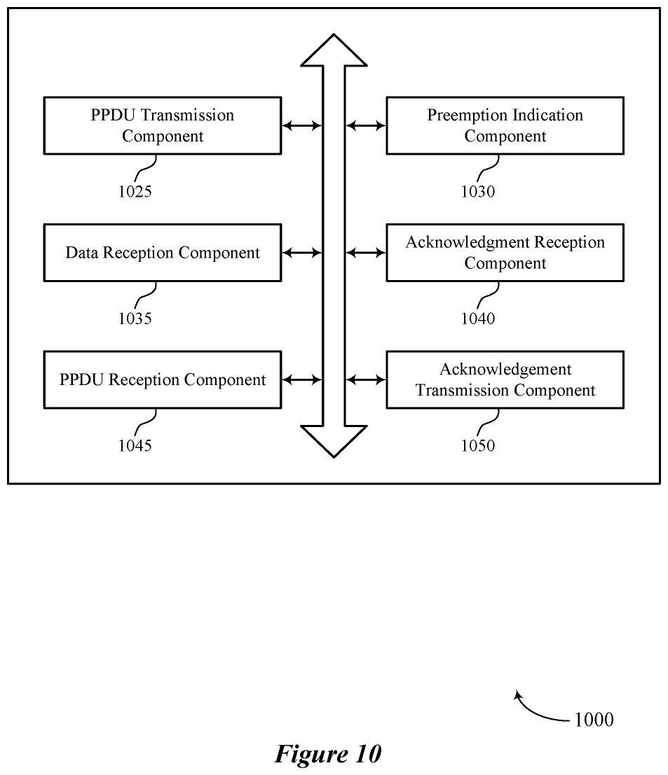

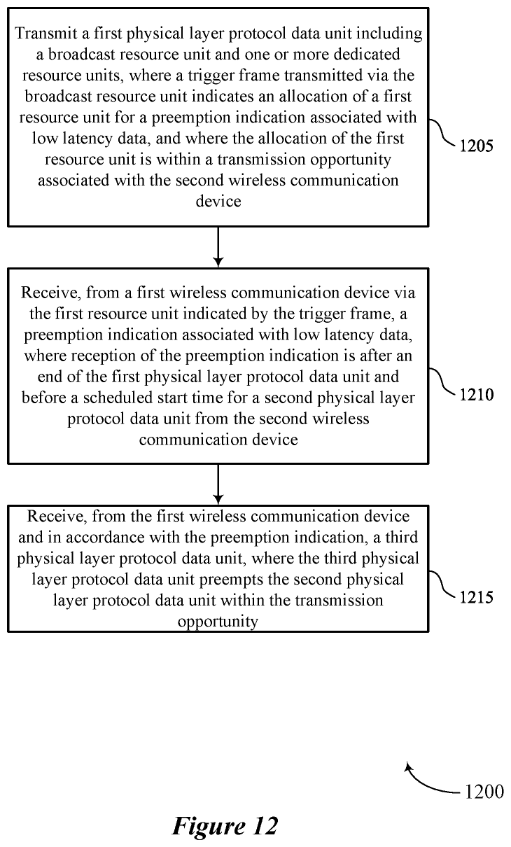

FIG. 10 shows a block diagram of an example wireless communication device 1000 that supports preemption techniques for low latency devices. In some examples, the wireless communication device 1000 is configured to perform the processes 1200, 1400, and 1600 described with reference to FIGS. 12, 14, and 16, respectively. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes a PPDU transmission component 1025, a preemption indication component 1030, a data reception component 1035, an acknowledgment reception component 1040, a PPDU reception component 1045, and an acknowledgment transmission component 1050. Portions of one or more of the PPDU transmission component 1025, the preemption indication component 1030, the data reception component 1035, the acknowledgment reception component 1040, the PPDU reception component 1045, and the acknowledgment transmission component 1050 may be implemented at least in part in hardware or firmware. For example, one or more of the PPDU transmission component 1025, the preemption indication component 1030, the data reception component 1035, the acknowledgment reception component 1040, the PPDU reception component 1045, and the acknowledgment transmission component 1050 may be implemented at least in part by at least a processor or a modem. In some examples, portions of one or more of the PPDU transmission component 1025, the preemption indication component 1030, the data reception component 1035, the acknowledgment reception component 1040, the PPDU reception component 1045, and the acknowledgment transmission component 1050 may be implemented at least in part by a processor and software in the form of processor-executable code stored in memory.

The wireless communication device 1000 may support wireless communications in accordance with examples as disclosed herein. The PPDU transmission component 1025 is configurable or configured to transmit a first PPDU including a broadcast RU and one or more dedicated RUs, where a trigger frame transmitted via the broadcast RU indicates an allocation of a first RU for a preemption indication associated with low latency data, and where the allocation of the first RU is within a TXOP associated with the second wireless communication device. The preemption indication component 1030 is configurable or configured to receive, from a first wireless communication device via the first RU indicated by the trigger frame, a preemption indication associated with low latency data, where reception of the preemption indication is after an end of the first PPDU and before a scheduled start time for a second PPDU from the second wireless communication device. The data reception component 1035 is configurable or configured to receive, from the first wireless communication device and in accordance with the preemption indication, a third PPDU, where the third PPDU preempts the second PPDU within the TXOP.

In some examples, to support transmitting the first PPDU, the PPDU transmission component 1025 is configurable or configured to transmit, via the one or more dedicated RUs, one or more frames to a third wireless communication device, where the one or more frames indicates a second allocation of a second RU for an acknowledgment to the first PPDU.

In some examples, the acknowledgment reception component 1040 is configurable or configured to receive the acknowledgment to the first PPDU via the second RU.

In some examples, the first RU and the second RU overlap in time.

In some examples, a trigger response scheduling control field control field in a medium access control header of a frame of the one or more frames indicates the second allocation of the second RU.

In some examples, to support transmitting the first PPDU, the PPDU transmission component 1025 is configurable or configured to transmit, via the one or more dedicated RUs, a second one or more frames to a fourth wireless communication device, where the second one or more frames indicates a third allocation of a third RU for an acknowledgment to the first PPDU.

In some examples, to support receiving the preemption indication associated with low latency data, the preemption indication component 1030 is configurable or configured to receive a set of multiple preemption indications associated with low latency data, where each preemption indication of the set of multiple preemption indications includes a same content.

In some examples, to support transmitting the first PPDU, the PPDU transmission component 1025 is configurable or configured to include, in a header of the first PPDU, an association identifier associated with low latency data.

In some examples, to support receiving the preemption indication, the preemption indication component 1030 is configurable or configured to receive a signaling frame including the preemption indication, where receiving the third PPDU is based on receiving the signaling frame.

In some examples, to support receiving the preemption indication, the preemption indication component 1030 is configurable or configured to receive a trigger-based PPDU including null A-MPDU delimiters, where receiving the third PPDU is based on the trigger-based PPDU.

In some examples, to support transmitting the first PPDU, the PPDU transmission component 1025 is configurable or configured to set a first NAV for a first set of wireless communication devices including at least the first wireless communication device. In some examples, to support transmitting the first PPDU, the PPDU transmission component 1025 is configurable or configured to set a second NAV for a second set of wireless communication devices that are not associated with low latency data.

In some examples, to support transmitting the first PPDU, the PPDU transmission component 1025 is configurable or configured to set a first NAV until after the first RU, where the third PPDU sets a second NAV.

In some examples, the first PPDU indicate a second allocation of a second RU for a second preemption indication associated with a second type of traffic. In some examples, the first PPDU include a traffic identifier, an access category, or a stream classification service identifier for the second type of traffic.

Additionally, or alternatively, the wireless communication device 1000 may support wireless communications in accordance with examples as disclosed herein. In some examples, the PPDU transmission component 1025 is configurable or configured to transmit a first PPDU within a TXOP associated with the second wireless communication device. The acknowledgment reception component 1040 is configurable or configured to receive a block acknowledgment in response to the first PPDU, where the block acknowledgment has a fixed size. In some examples, the preemption indication component 1030 is configurable or configured to receive, from a first wireless communication device, a preemption indication associated with low latency data in an interframe space after an end time of the block acknowledgment to the first PPDU and before a scheduled start time for a second PPDU from the second wireless communication device based on the fixed size of the block acknowledgment. In some examples, the data reception component 1035 is configurable or configured to receive, in accordance with the preemption indication, a third PPDU, where the third PPDU preempts the second PPDU within the TXOP.

Additionally, or alternatively, the wireless communication device 1000 may support wireless communications in accordance with examples as disclosed herein. The PPDU reception component 1045 is configurable or configured to receive, from a first wireless communication device, a first physical layer protocol data unit within a transmission opportunity associated with the first wireless communication device, where the first physical layer protocol data unit includes an indication that preemption for low latency data is enabled. The acknowledgment transmission component 1050 is configurable or configured to transmit an acknowledgment in response to the first physical layer protocol data unit, where the acknowledgment includes a preemption indication associated with low latency data based on the indication that preemption for low latency data is enabled. In some examples, the PPDU transmission component 1025 is configurable or configured to transmit, in accordance with the preemption indication, a second physical layer protocol data unit within the transmission opportunity associated with the first wireless communication device.

In some examples, the PPDU reception component 1045 is configurable or configured to receive, from the first wireless communication device, a third physical layer protocol data unit within the transmission opportunity associated with the first wireless communication device, where the third physical layer protocol data unit includes a second indication that preemption for low latency data is enabled. In some examples, the acknowledgment transmission component 1050 is configurable or configured to transmit a second acknowledgment in response to the third physical layer protocol data unit, where the second acknowledgment includes an indication that the second wireless communication device does not have low latency data.

In some examples, to support transmitting the second physical layer protocol data unit, the PPDU transmission component 1025 is configurable or configured to transmit the second physical layer protocol data unit to the first wireless communication device.

In some examples, the PPDU transmission component 1025 is configurable or configured to transmit, in accordance with preemption indication, a fourth physical layer protocol data unit within the transmission opportunity to a third wireless communication device.

In some examples, to support transmitting the second physical layer protocol data unit, the PPDU transmission component 1025 is configurable or configured to transmit the second physical layer protocol data unit to a third wireless communication device.

FIG. 11 shows a flowchart illustrating an example process 1100 performable by or at a first wireless communication device that supports preemption techniques for low-latency devices. The operations of the process 1100 may be implemented by a first wireless communication device or its components as described herein. For example, the process 1100 may be performed by a wireless communication device, such as the wireless communication device 900 described with reference to FIG. 9, operating as or within a wireless STA. In some examples, the process 1100 may be performed by a wireless STA, such as one of the STAs 104 described with reference to FIG. 1.

In some examples, in block 1105, the first wireless communication device may receive, from a second wireless communication device, a first physical layer protocol data unit that indicates an allocation of a first resource unit for a preemption indication associated with low latency data, where the allocation of the first resource unit is within a transmission opportunity associated with the second wireless communication device. The operations of block 1105 may be performed in accordance with examples as disclosed herein. In some implementations, aspects of the operations of block 1105 may be performed by a PPDU reception component 925 as described with reference to FIG. 9.

In some examples, in block 1110, the first wireless communication device may transmit, via the first resource unit indicated by the first physical layer protocol data unit, the preemption indication associated with low latency data based on low latency data information at the first wireless communication device, where transmission of the preemption indication is after an end of the first physical layer protocol data unit and before a scheduled start time for a second physical layer protocol data unit from the second wireless communication device. The operations of block 1110 may be performed in accordance with examples as disclosed herein. In some implementations, aspects of the operations of block 1110 may be performed by a preemption indication component 930 as described with reference to FIG. 9.

In some examples, in block 1115, the first wireless communication device may transmit, based in accordance with the preemption indication, a third physical layer protocol data unit including the low latency data information, where the third physical layer protocol data unit preempts the second physical layer protocol data unit within the transmission opportunity. The operations of block 1115 may be performed in accordance with examples as disclosed herein. In some implementations, aspects of the operations of block 1115 may be performed by a data transmission component 935 as described with reference to FIG. 9.

FIG. 12 shows a flowchart illustrating an example process 1200 performable by or at a second wireless communication device that supports preemption techniques for low-latency devices. The operations of the process 1200 may be implemented by a second wireless communication device or its components as described herein. For example, the process 1200 may be performed by a wireless communication device, such as the wireless communication device 1000 described with reference to FIG. 10, operating as or within a wireless AP. In some examples, the process 1200 may be performed by a wireless AP, such as one of the Aps 102 described with reference to FIG. 1.

In some examples, in block 1205, the second wireless communication device may transmit a first physical layer protocol data unit including a broadcast resource unit and one or more dedicated resource units, where a trigger frame transmitted via the broadcast resource unit indicates an allocation of a first resource unit for a preemption indication associated with low latency data, and where the allocation of the first resource unit is within a transmission opportunity associated with the second wireless communication device. The operations of block 1205 may be performed in accordance with examples as disclosed herein. In some implementations, aspects of the operations of block 1205 may be performed by a PPDU transmission component 1025 as described with reference to FIG. 10.

In some examples, in block 1210, the second wireless communication device may receive, from a first wireless communication device via the first resource unit indicated by the trigger frame, a preemption indication associated with low latency data, where reception of the preemption indication is after an end of the first physical layer protocol data unit and before a scheduled start time for a second physical layer protocol data unit from the second wireless communication device. The operations of block 1210 may be performed in accordance with examples as disclosed herein. In some implementations, aspects of the operations of block 1210 may be performed by a preemption indication component 1030 as described with reference to FIG. 10.

In some examples, in block 1215, the second wireless communication device may receive, from the first wireless communication device and in accordance with the preemption indication, a third physical layer protocol data unit, where the third physical layer protocol data unit preempts the second physical layer protocol data unit within the transmission opportunity. The operations of block 1215 may be performed in accordance with examples as disclosed herein. In some implementations, aspects of the operations of block 1215 may be performed by a data reception component 1035 as described with reference to FIG. 10.

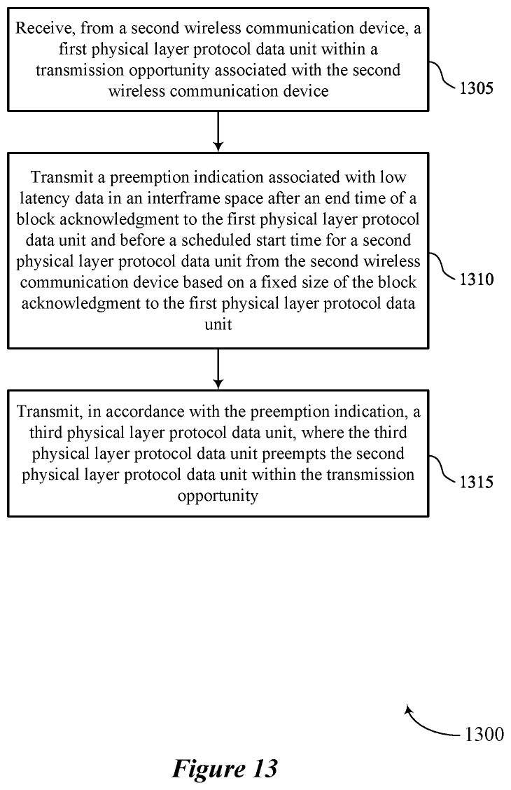

FIG. 13 shows a flowchart illustrating an example process 1300 performable by or at a first wireless communication device that supports preemption techniques for low-latency devices. The operations of the process 1300 may be implemented by a first wireless communication device or its components as described herein. For example, the process 1300 may be performed by a wireless communication device, such as the wireless communication device 900 described with reference to FIG. 9, operating as or within a wireless STA. In some examples, the process 1300 may be performed by a wireless STA, such as one of the STAs 104 described with reference to FIG. 1.

In some examples, in block 1305, the first wireless communication device may receive, from a second wireless communication device, a first physical layer protocol data unit within a transmission opportunity associated with the second wireless communication device. The operations of block 1305 may be performed in accordance with examples as disclosed herein. In some implementations, aspects of the operations of block 1305 may be performed by a PPDU reception component 925 as described with reference to FIG. 9.

In some examples, in block 1310, the first wireless communication device may transmit a preemption indication associated with low latency data in an interframe space after an end time of a block acknowledgment to the first physical layer protocol data unit and before a scheduled start time for a second physical layer protocol data unit from the second wireless communication device based on a fixed size of the block acknowledgment to the first physical layer protocol data unit. The operations of block 1310 may be performed in accordance with examples as disclosed herein. In some implementations, aspects of the operations of block 1310 may be performed by a preemption indication component 930 as described with reference to FIG. 9.

In some examples, in block 1315, the first wireless communication device may transmit, in accordance with the preemption indication, a third physical layer protocol data unit, where the third physical layer protocol data unit preempts the second physical layer protocol data unit within the transmission opportunity. The operations of block 1315 may be performed in accordance with examples as disclosed herein. In some implementations, aspects of the operations of block 1315 may be performed by a data transmission component 935 as described with reference to FIG. 9.

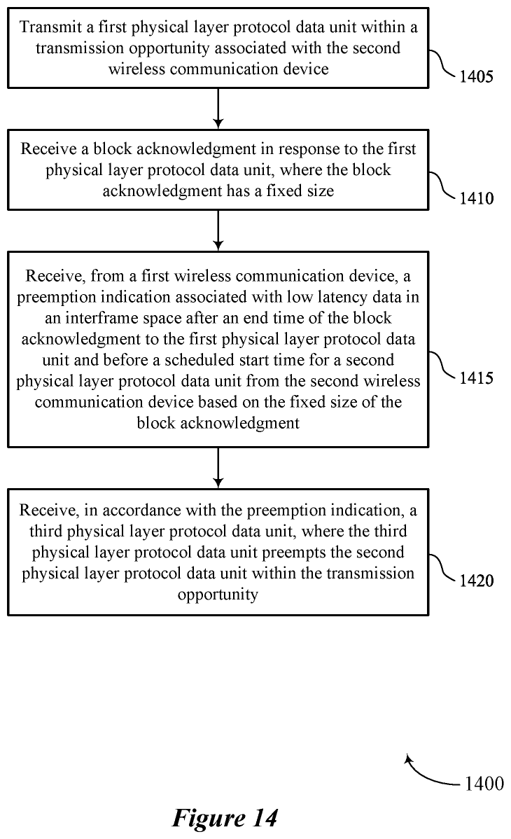

FIG. 14 shows a flowchart illustrating an example process 1400 performable by or at a second wireless communication device that supports preemption techniques for low-latency devices. The operations of the process 1400 may be implemented by a second wireless communication device or its components as described herein. For example, the process 1400 may be performed by a wireless communication device, such as the wireless communication device 1000 described with reference to FIG. 10, operating as or within a wireless AP. In some examples, the process 1400 may be performed by a wireless AP, such as one of the Aps 102 described with reference to FIG. 1.

In some examples, in block 1405, the second wireless communication device may transmit a first physical layer protocol data unit within a transmission opportunity associated with the second wireless communication device. The operations of block 1405 may be performed in accordance with examples as disclosed herein. In some implementations, aspects of the operations of block 1405 may be performed by a PPDU transmission component 1025 as described with reference to FIG. 10.

In some examples, in block 1410, the second wireless communication device may receive a block acknowledgment in response to the first physical layer protocol data unit, where the block acknowledgment has a fixed size. The operations of block 1410 may be performed in accordance with examples as disclosed herein. In some implementations, aspects of the operations of block 1410 may be performed by an acknowledgment reception component 1040 as described with reference to FIG. 10.

In some examples, in block 1415, the second wireless communication device may receive, from a first wireless communication device, a preemption indication associated with low latency data in an interframe space after an end time of the block acknowledgment to the first physical layer protocol data unit and before a scheduled start time for a second physical layer protocol data unit from the second wireless communication device based on the fixed size of the block acknowledgment. The operations of block 1415 may be performed in accordance with examples as disclosed herein. In some implementations, aspects of the operations of block 1415 may be performed by a preemption indication component 1030 as described with reference to FIG. 10.

In some examples, in block 1420, the second wireless communication device may receive, in accordance with the preemption indication, a third physical layer protocol data unit, where the third physical layer protocol data unit preempts the second physical layer protocol data unit within the transmission opportunity. The operations of block 1420 may be performed in accordance with examples as disclosed herein. In some implementations, aspects of the operations of block 1420 may be performed by a data reception component 1035 as described with reference to FIG. 10.

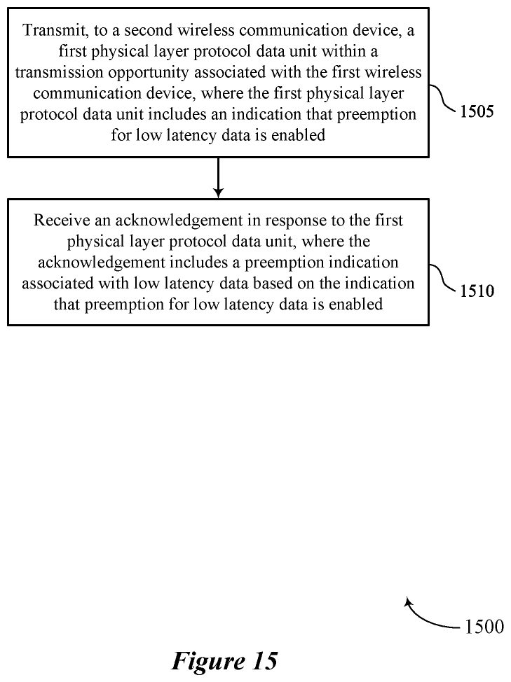

FIG. 15 shows a flowchart illustrating an example process 1500 performable by or at a first wireless communication device that supports preemption techniques for low-latency devices. The operations of the process 1500 may be implemented by a first wireless communication device or its components as described herein. For example, the process 1500 may be performed by a wireless communication device, such as the wireless communication device 900 described with reference to FIG. 9, operating as or within a wireless STA. In some examples, the process 1500 may be performed by a wireless STA, such as one of the STAs 104 described with reference to FIG. 1.

In some examples, in block 1505, the first wireless communication device may transmit, to a second wireless communication device, a first physical layer protocol data unit within a transmission opportunity associated with the first wireless communication device, where the first physical layer protocol data unit includes an indication that preemption for low latency data is enabled. The operations of block 1505 may be performed in accordance with examples as disclosed herein. In some implementations, aspects of the operations of block 1505 may be performed by a PPDU transmission component 940 as described with reference to FIG. 9.

In some examples, in block 1510, the first wireless communication device may receive an acknowledgment in response to the first physical layer protocol data unit, where the acknowledgment includes a preemption indication associated with low latency data based on the indication that preemption for low latency data is enabled. The operations of block 1510 may be performed in accordance with examples as disclosed herein. In some implementations, aspects of the operations of block 1510 may be performed by an acknowledgment reception component 945 as described with reference to FIG. 9.

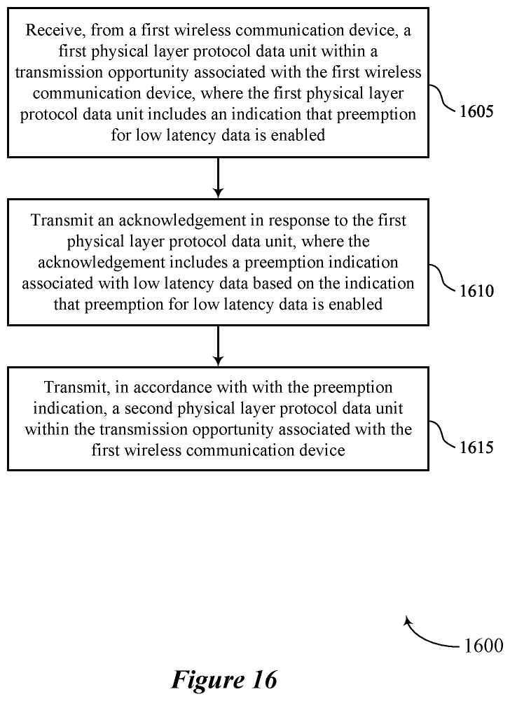

FIG. 16 shows a flowchart illustrating an example process 1600 performable by or at a second wireless communication device that supports preemption techniques for low-latency devices. The operations of the process 1600 may be implemented by a second wireless communication device or its components as described herein. For example, the process 1600 may be performed by a wireless communication device, such as the wireless communication device 1000 described with reference to FIG. 10, operating as or within a wireless AP. In some examples, the process 1600 may be performed by a wireless AP, such as one of the Aps 102 described with reference to FIG. 1.

In some examples, in block 1605, the second wireless communication device may receive, from a first wireless communication device, a first physical layer protocol data unit within a transmission opportunity associated with the first wireless communication device, where the first physical layer protocol data unit includes an indication that preemption for low latency data is enabled. The operations of block 1605 may be performed in accordance with examples as disclosed herein. In some implementations, aspects of the operations of block 1605 may be performed by a PPDU reception component 1045 as described with reference to FIG. 10.

In some examples, in block 1610, the second wireless communication device may transmit an acknowledgment in response to the first physical layer protocol data unit, where the acknowledgment includes a preemption indication associated with low latency data based on the indication that preemption for low latency data is enabled. The operations of block 1610 may be performed in accordance with examples as disclosed herein. In some implementations, aspects of the operations of block 1610 may be performed by an acknowledgment transmission component 1050 as described with reference to FIG. 10.

In some examples, in block 1615, the second wireless communication device may transmit, in accordance with the preemption indication, a second physical layer protocol data unit within the transmission opportunity associated with the first wireless communication device. The operations of block 1615 may be performed in accordance with examples as disclosed herein. In some implementations, aspects of the operations of block 1615 may be performed by a PPDU transmission component 1025 as described with reference to FIG. 10.

Implementation examples are described in the following numbered clauses:

Aspect 1: A method for wireless communications at a first wireless communication device, comprising: receiving, from a second wireless communication device, a first physical layer protocol data unit that indicates an allocation of a first RU for a preemption indication associated with low latency data, wherein the allocation of the first resource unit is within a transmission opportunity associated with the second wireless communication device; transmitting, via the first resource unit indicated by the first physical layer protocol data unit, the preemption indication associated with low latency data based at least in part on low latency data information at the first wireless communication device, wherein transmission of the preemption indication is after an end of the first physical layer protocol data unit and before a scheduled start time for a second physical layer protocol data unit from the second wireless communication device; and transmitting, based in accordance with the preemption indication, a third physical layer protocol data unit comprising the low latency data information, wherein the third physical layer protocol data unit preempts the second physical layer protocol data unit within the transmission opportunity.

Aspect 2: The method of aspect 1, wherein receiving the first physical layer protocol data unit comprises: receiving, via a broadcast resource unit, a trigger frame that indicates the allocation of the first resource unit for the preemption indication associated with low latency data, wherein the first physical layer protocol data unit comprises the broadcast resource unit and one or more dedicated resource units.

Aspect 3: The method of aspect 2, further comprising: decoding signaling on the broadcast resource unit of the first physical layer protocol data unit based at least in part on a wireless station identifier of the broadcast resource unit.

Aspect 4: The method of any of aspects 1 through 3, further comprising: decoding the first physical layer protocol data unit based at least in part on an association identifier associated with low latency data.

Aspect 5: The method of any of aspects 1 through 4, wherein transmitting the preemption indication comprises: transmitting a signaling frame comprising the preemption indication, wherein transmitting the third physical layer protocol data unit is based at least in part on transmitting the signaling frame.

Aspect 6: The method of any of aspects 1 through 5, wherein transmitting the preemption indication comprises: transmitting a trigger-based physical layer protocol data unit comprising null aggregate Medium Access Control (MAC) protocol data unit delimiters, wherein transmitting the third physical layer protocol data unit is based at least in part on the trigger-based physical layer protocol data unit.

Aspect 7: The method of any of aspects 1 through 6, further comprising: generating the preemption indication based at least in part on information indicated by the first physical layer protocol data unit.

Aspect 8: The method of any of aspects 1 through 7, wherein the first physical layer protocol data unit sets a first network allocation vector (NAV) for a first set of wireless communication devices comprising at least the first wireless communication device, and the third physical layer protocol data unit sets a second NAV for a second set of wireless communication devices that are not associated with low latency data.

Aspect 9: The method of any of aspects 1 through 8, wherein the first physical layer protocol data unit sets a first network allocation vector (NAV), the method further comprising: setting a second NAV based at least in part on transmission of the third physical layer protocol data unit.

Aspect 10: The method of any of aspects 1 through 9, wherein the first physical layer protocol data unit indicates a second allocation of a second resource unit for a second preemption indication associated with a second type of traffic, and the first physical layer protocol data unit comprises a traffic identifier, an access category, or a stream classification service identifier for the second type of traffic.

Aspect 11: The method of any of aspects 1 through 10, wherein the first resource unit is a random access resource unit.

Aspect 12: The method of aspect 11, wherein the random access resource unit is associated with a traffic category.

Aspect 13: The method of any of aspects 1 through 12, wherein transmitting the preemption indication comprises: transmitting the preemption indicator without performing a resource unit countdown, a listen before talk procedure, or a channel access countdown, or any combination thereof.

Aspect 14: A method for wireless communications at a second wireless communication device, comprising: transmitting a first physical layer protocol data unit comprising a broadcast resource unit and one or more dedicated resource units, wherein a trigger frame transmitted via the broadcast resource unit indicates an allocation of a first resource unit for a preemption indication associated with low latency data, and wherein the allocation of the first resource unit is within a transmission opportunity associated with the second wireless communication device; receiving, from a first wireless communication device via the first resource unit indicated by the trigger frame, a preemption indication associated with low latency data, wherein reception of the preemption indication is after an end of the first physical layer protocol data unit and before a scheduled start time for a second physical layer protocol data unit from the second wireless communication device; and receiving, from the first wireless communication device and in accordance with the preemption indication, a third physical layer protocol data unit, wherein the third physical layer protocol data unit preempts the second physical layer protocol data unit within the transmission opportunity.

Aspect 15: The method of aspect 14, wherein transmitting the first physical layer protocol data unit comprises: transmitting, via the one or more dedicated resource units, one or more frames to a third wireless communication device, wherein the one or more frames indicates a second allocation of a second resource unit for an acknowledgment to the first physical layer protocol data unit.

Aspect 16: The method of aspect 15, further comprising: receiving the acknowledgment to the first physical layer protocol data unit via the second resource unit.

Aspect 17: The method of any of aspects 15 through 16, wherein the first resource unit and the second resource unit overlap in time.

Aspect 18: The method of any of aspects 15 through 17, wherein a triggered response scheduling control field control field in a medium access control header of a frame of the one or more frames indicates the second allocation of the second resource unit.

Aspect 19: The method of any of aspects 15 through 18, wherein transmitting the first physical layer protocol data unit comprises: transmitting, via the one or more dedicated resource units, a second one or more frames to a fourth wireless communication device, wherein the second one or more frames indicates a third allocation of a third resource unit for an acknowledgment to the first physical layer protocol data unit.

Aspect 20: The method of any of aspects 14 through 19, wherein receiving the preemption indication associated with low latency data comprises: receiving a plurality of preemption indications associated with low latency data, wherein each preemption indication of the plurality of preemption indications comprises a same content.

Aspect 21: The method of any of aspects 14 through 20, wherein transmitting the first physical layer protocol data unit comprises: including, in a header of the first physical layer protocol data unit, an association identifier associated with low latency data.

Aspect 22: The method of any of aspects 14 through 21, wherein receiving the preemption indication comprises: receiving a signaling frame comprising the preemption indication, wherein receiving the third physical layer protocol data unit is based at least in part on receiving the signaling frame.

Aspect 23: The method of any of aspects 14 through 22, wherein receiving the preemption indication comprises: receiving a trigger-based physical layer protocol data unit comprising null aggregate Medium Access Control (MAC) protocol data unit delimiters, wherein receiving the third physical layer protocol data unit is based at least in part on the trigger-based physical layer protocol data unit.

Aspect 24: The method of any of aspects 14 through 23, wherein transmitting the first physical layer protocol data unit comprises: setting a first network allocation vector (NAV) for a first set of wireless communication devices comprising at least the first wireless communication device; and setting a second NAV for a second set of wireless communication devices that are not associated with low latency data.

Aspect 25: The method of any of aspects 14 through 24, wherein transmitting the first physical layer protocol data unit comprises: setting a first network allocation vector (NAV) until after the first resource unit, wherein the third physical layer protocol data unit sets a second NAV.

Aspect 26: The method of any of aspects 14 through 25, wherein the first physical layer protocol data unit indicates a second allocation of a second resource unit for a second preemption indication associated with a second type of traffic, and the first physical layer protocol data unit comprises a traffic identifier, an access category, or a stream classification service identifier for the second type of traffic.

Aspect 27: A method for wireless communications at a first wireless communication device, comprising: receiving, from a second wireless communication device, a first physical layer protocol data unit within a transmission opportunity associated with the second wireless communication device; transmitting a preemption indication associated with low latency data in an interframe space after an end time of a block acknowledgment to the first physical layer protocol data unit and before a scheduled start time for a second physical layer protocol data unit from the second wireless communication device based at least in part on a fixed size of the block acknowledgment to the first physical layer protocol data unit; and transmitting, in accordance with the preemption indication, a third physical layer protocol data unit, wherein the third physical layer protocol data unit preempts the second physical layer protocol data unit within the transmission opportunity.

Aspect 28: A method for wireless communications at a second wireless communication device, comprising: transmitting a first physical layer protocol data unit within a transmission opportunity associated with the second wireless communication device; receiving a block acknowledgment in response to the first physical layer protocol data unit, wherein the block acknowledgment has a fixed size; receiving, from a first wireless communication device, a preemption indication associated with low latency data in an interframe space after an end time of the block acknowledgment to the first physical layer protocol data unit and before a scheduled start time for a second physical layer protocol data unit from the second wireless communication device based at least in part on the fixed size of the block acknowledgment; and receiving, in accordance with the preemption indication, a third physical layer protocol data unit, wherein the third physical layer protocol data unit preempts the second physical layer protocol data unit within the transmission opportunity.

Aspect 29: A method for wireless communications at a first wireless communication device, comprising: transmitting, to a second wireless communication device, a first physical layer protocol data unit within a transmission opportunity associated with the first wireless communication device, wherein the first physical layer protocol data unit includes an indication that preemption for low latency data is enabled; and receiving an acknowledgment in response to the first physical layer protocol data unit, wherein the acknowledgment includes a preemption indication associated with low latency data based at least in part on the indication that preemption for low latency data is enabled.

Aspect 30: The method of aspect 29, further comprising: transmitting, to the second wireless communication device, a third physical layer protocol data unit within the transmission opportunity associated with the first wireless communication device, wherein the third physical layer protocol data unit includes a second indication that preemption for low latency data is enabled; and receiving a second acknowledgment in response to the third physical layer protocol data unit, wherein the second acknowledgment includes an indication that the second wireless communication device does not have low latency data.

Aspect 31: The method of any of aspects 29 through 30, further comprising: receiving, in accordance with the preemption indication, a second physical layer protocol data unit from the second wireless communication device within the transmission opportunity associated with the first wireless communication device.

Aspect 32: The method of any of aspects 29 through 31, further comprising: deferring a remainder of the transmission opportunity associated with the first wireless communication device to the second wireless communication device in accordance with the preemption indication.

Aspect 33: A method for wireless communications at a second wireless communication device, comprising: receiving, from a first wireless communication device, a first physical layer protocol data unit within a transmission opportunity associated with the first wireless communication device, wherein the first physical layer protocol data unit includes an indication that preemption for low latency data is enabled; transmitting an acknowledgment in response to the first physical layer protocol data unit, wherein the acknowledgment includes a preemption indication associated with low latency data based at least in part on the indication that preemption for low latency data is enabled; and transmitting, in accordance with the preemption indication, a second physical layer protocol data unit within the transmission opportunity associated with the first wireless communication device.

Aspect 34: The method of aspect 33, further comprising: receiving, from the first wireless communication device, a third physical layer protocol data unit within the transmission opportunity associated with the first wireless communication device, wherein the third physical layer protocol data unit includes a second indication that preemption for low latency data is enabled; and transmitting a second acknowledgment in response to the third physical layer protocol data unit, wherein the second acknowledgment includes an indication that the second wireless communication device does not have low latency data.

Aspect 35: The method of any of aspects 33 through 34, wherein transmitting the second physical layer protocol data unit comprises: transmitting the second physical layer protocol data unit to the first wireless communication device.

Aspect 36: The method of aspect 35, further comprising: transmitting, in accordance with preemption indication, a fourth physical layer protocol data unit within the transmission opportunity to a third wireless communication device.

Aspect 37: The method of any of aspects 33 through 36, wherein transmitting the second physical layer protocol data unit comprises: transmitting the second physical layer protocol data unit to a third wireless communication device.

Aspect 38: A first wireless communication device for wireless communications, comprising a processing system that includes processor circuitry and memory circuitry that stores code, the processing system configured to cause the first wireless communication device to perform a method of any of aspects 1 through 13.

Aspect 39: A first wireless communication device for wireless communications, comprising at least one means for performing a method of any of aspects 1 through 13.

Aspect 40: A non-transitory computer-readable medium storing code for wireless communications, the code comprising instructions executable by one or more processors to perform a method of any of aspects 1 through 13.

Aspect 41: A second wireless communication device for wireless communications, comprising a processing system that includes processor circuitry and memory circuitry that stores code, the processing system configured to cause the first wireless communication device to perform a method of any of aspects 14 through 26.

Aspect 42: A second wireless communication device for wireless communications, comprising at least one means for performing a method of any of aspects 14 through 26.

Aspect 43: A non-transitory computer-readable medium storing code for wireless communications, the code comprising instructions executable by one or more processors to perform a method of any of aspects 14 through 26.

Aspect 44: A first wireless communication device for wireless communications, comprising a processing system that includes processor circuitry and memory circuitry that stores code, the processing system configured to cause the first wireless communication device to perform a method of any of aspects 27 through 27.

Aspect 45: A first wireless communication device for wireless communications, comprising at least one means for performing a method of any of aspects 27 through 27.

Aspect 46: A non-transitory computer-readable medium storing code for wireless communications, the code comprising instructions executable by one or more processors to perform a method of any of aspects 27 through 27.

Aspect 47: A second wireless communication device for wireless communications, comprising a processing system that includes processor circuitry and memory circuitry that stores code, the processing system configured to cause the first wireless communication device to perform a method of any of aspects 28 through 28.

Aspect 48: A second wireless communication device for wireless communications, comprising at least one means for performing a method of any of aspects 28 through 28.

Aspect 49: A non-transitory computer-readable medium storing code for wireless communications, the code comprising instructions executable by one or more processors to perform a method of any of aspects 28 through 28.

Aspect 50: A first wireless communication device for wireless communications, comprising a processing system that includes processor circuitry and memory circuitry that stores code, the processing system configured to cause the first wireless communication device to perform a method of any of aspects 29 through 32.

Aspect 51: A first wireless communication device for wireless communications, comprising at least one means for performing a method of any of aspects 29 through 32.

Aspect 52: A non-transitory computer-readable medium storing code for wireless communications, the code comprising instructions executable by one or more processors to perform a method of any of aspects 29 through 32.

Aspect 53: A second wireless communication device for wireless communications, comprising a processing system that includes processor circuitry and memory circuitry that stores code, the processing system configured to cause the first wireless communication device to perform a method of any of aspects 33 through 37.

Aspect 54: A second wireless communication device for wireless communications, comprising at least one means for performing a method of any of aspects 33 through 37.

Aspect 55: A non-transitory computer-readable medium storing code for wireless communications, the code comprising instructions executable by one or more processors to perform a method of any of aspects 33 through 37.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes processor circuitry and memory circuitry that stores code, the processing system configured to cause the first wireless communication device to:
receive, from a second wireless communication device, a first physical layer protocol data unit that indicates an allocation of a first resource unit for a preemption indication associated with low latency data, wherein the allocation of the first resource unit is within a transmission opportunity associated with the second wireless communication device;
transmit, via the first resource unit indicated by the first physical layer protocol data unit, the preemption indication associated with low latency data based at least in part on low latency data information at the first wireless communication device, wherein transmission of the preemption indication is after an end of the first physical layer protocol data unit and before a scheduled start time for a second physical layer protocol data unit from the second wireless communication device; and
transmit, in accordance with the preemption indication, a third physical layer protocol data unit comprising the low latency data information, wherein the third physical layer protocol data unit preempts the second physical layer protocol data unit within the transmission opportunity.

2. The first wireless communication device of claim 1, wherein, to receive the first physical layer protocol data unit, the processing system is configured to cause the first wireless communication device to:
receive, via a broadcast resource unit, a trigger frame that indicates the allocation of the first resource unit for the preemption indication associated with low latency data, wherein the first physical layer protocol data unit comprises the broadcast resource unit and one or more dedicated resource units.

3. The first wireless communication device of claim 2, wherein the processing system is further configured to cause the first wireless communication device to:
decode signaling on the broadcast resource unit of the first physical layer protocol data unit based at least in part on a wireless station identifier of the broadcast resource unit.

4. The first wireless communication device of claim 1, wherein the processing system is further configured to cause the first wireless communication device to:
decode the first physical layer protocol data unit based at least in part on an association identifier associated with low latency data.

5. The first wireless communication device of claim 1, wherein, to transmit the preemption indication, the processing system is configured to cause the first wireless communication device to:
transmit a signaling frame comprising the preemption indication, wherein transmitting the third physical layer protocol data unit is based at least in part on transmitting the signaling frame.

6. The first wireless communication device of claim 1, wherein, to transmit the preemption indication, the processing system is configured to cause the first wireless communication device to:
transmit a trigger-based physical layer protocol data unit comprising null aggregate Medium Access Control (MAC) protocol data unit delimiters, wherein transmitting the third physical layer protocol data unit is based at least in part on the trigger-based physical layer protocol data unit.

7. The first wireless communication device of claim 1, wherein the processing system is further configured to cause the first wireless communication device to:
generate the preemption indication based at least in part on information indicated by the first physical layer protocol data unit.

8. The first wireless communication device of claim 1, wherein the first physical layer protocol data unit sets a first network allocation vector (NAV) for a first set of wireless communication devices comprising at least the first wireless communication device, and the third physical layer protocol data unit sets a second NAV for a second set of wireless communication devices that are not associated with low latency data.

9. The first wireless communication device of claim 1, wherein the first physical layer protocol data unit sets a first network allocation vector (NAV), and the processing system is further configured to cause the first wireless communication device to:
set a second NAV based at least in part on transmission of the third physical layer protocol data unit.

10. The first wireless communication device of claim 1, wherein the first physical layer protocol data unit indicates a second allocation of a second resource unit for a second preemption indication associated with a second type of traffic, and the first physical layer protocol data unit comprises a traffic identifier, an access category, or a stream classification service identifier for the second type of traffic.

11. The first wireless communication device of claim 1, wherein the first resource unit is a random access resource unit.

12. The first wireless communication device of claim 11, wherein the random access resource unit is associated with a traffic category.

13. The first wireless communication device of claim 1, wherein, to transmit the preemption indication, the processing system is configured to cause the first wireless communication device to:
transmit the preemption indication without performing a resource unit countdown, a listen before talk procedure, or a channel access countdown, or any combination thereof.

14. A second wireless communication device, comprising:
a processing system that includes processor circuitry and memory circuitry that stores code, the processing system configured to cause the second wireless communication device to:
transmit a first physical layer protocol data unit comprising a broadcast resource unit and one or more dedicated resource units, wherein a trigger frame transmitted via the broadcast resource unit indicates an allocation of a first resource unit for a preemption indication associated with low latency data, and wherein the allocation of the first resource unit is within a transmission opportunity associated with the second wireless communication device;
receive, from a first wireless communication device via the first resource unit indicated by the trigger frame, a preemption indication associated with low latency data, wherein reception of the preemption indication is after an end of the first physical layer protocol data unit and before a scheduled start time for a second physical layer protocol data unit from the second wireless communication device; and
receive, from the first wireless communication device and in accordance with the preemption indication, a third physical layer protocol data unit, wherein the third physical layer protocol data unit preempts the second physical layer protocol data unit within the transmission opportunity.

15. The second wireless communication device of claim 14, wherein, to transmit the first physical layer protocol data unit, the processing system is configured to cause the second wireless communication device to:
transmit, via the one or more dedicated resource units, one or more frames to a third wireless communication device, wherein the one or more frames indicates a second allocation of a second resource unit for an acknowledgment to the first physical layer protocol data unit.

16. The second wireless communication device of claim 15, wherein the processing system is further configured to cause the second wireless communication device to:
receive the acknowledgment to the first physical layer protocol data unit via the second resource unit.

17. The second wireless communication device of claim 15, wherein:
the first resource unit and the second resource unit overlap in time.

18. The second wireless communication device of claim 15, wherein a triggered response scheduling control field control field in a medium access control header of a frame of the one or more frames indicates the second allocation of the second resource unit.

19. The second wireless communication device of claim 15, wherein, to transmit the first physical layer protocol data unit, the processing system is configured to cause the second wireless communication device to:
transmit, via the one or more dedicated resource units, a second one or more frames to a fourth wireless communication device, wherein the second one or more frames indicates a third allocation of a third resource unit for an acknowledgment to the first physical layer protocol data unit.

20. The second wireless communication device of claim 14, wherein, to receive the preemption indication associated with low latency data, the processing system is configured to cause the second wireless communication device to:
receive a plurality of preemption indications associated with low latency data, wherein each preemption indication of the plurality of preemption indications comprises a same content.

21. The second wireless communication device of claim 14, wherein, to transmit the first physical layer protocol data unit, the processing system is configured to cause the second wireless communication device to:
include, in a header of the first physical layer protocol data unit, an association identifier associated with low latency data.

22. The second wireless communication device of claim 14, wherein, to receive the preemption indication, the processing system is configured to cause the second wireless communication device to:
receive a signaling frame comprising the preemption indication, wherein receiving the third physical layer protocol data unit is based at least in part on receiving the signaling frame.

23. The second wireless communication device of claim 14, wherein, to receive the preemption indication, the processing system is configured to cause the second wireless communication device to:
receive a trigger-based physical layer protocol data unit comprising null aggregate Medium Access Control (MAC) protocol data unit delimiters, wherein receiving the third physical layer protocol data unit is based at least in part on the trigger-based physical layer protocol data unit.

24. The second wireless communication device of claim 14, wherein, to transmit the first physical layer protocol data unit, the processing system is configured to cause the second wireless communication device to:
set a first network allocation vector (NAV) for a first set of wireless communication devices comprising at least the first wireless communication device; and
set a second NAV for a second set of wireless communication devices that are not associated with low latency data.

25. The second wireless communication device of claim 14, wherein, to transmit the first physical layer protocol data unit, the processing system is configured to cause the second wireless communication device to:
set a first network allocation vector (NAV) until after the first resource unit, wherein the third physical layer protocol data unit sets a second NAV.

26. A first wireless communication device, comprising:
a processing system that includes processor circuitry and memory circuitry that stores code, the processing system configured to cause the first wireless communication device to:
receive, from a second wireless communication device, a first physical layer protocol data unit within a transmission opportunity associated with the second wireless communication device;
transmit a preemption indication associated with low latency data in an interframe space after an end time of a block acknowledgment to the first physical layer protocol data unit and before a scheduled start time for a second physical layer protocol data unit from the second wireless communication device based at least in part on a fixed size of the block acknowledgment to the first physical layer protocol data unit; and
transmit, in accordance with the preemption indication, a third physical layer protocol data unit, wherein the third physical layer protocol data unit preempts the second physical layer protocol data unit within the transmission opportunity.

27. A first wireless communication device, comprising:
a processing system that includes processor circuitry and memory circuitry that stores code, the processing system configured to cause the first wireless communication device to:
transmit, to a second wireless communication device, a first physical layer protocol data unit within a transmission opportunity associated with the first wireless communication device, wherein the first physical layer protocol data unit includes an indication that preemption for low latency data is enabled; and
receive an acknowledgment in response to the first physical layer protocol data unit, wherein the acknowledgment includes a preemption indication associated with low latency data based at least in part on the indication that preemption for low latency data is enabled.

28. The first wireless communication device of claim 27, wherein the processing system is further configured to cause the first wireless communication device to:
transmit, to the second wireless communication device, a third physical layer protocol data unit within the transmission opportunity associated with the first wireless communication device, wherein the third physical layer protocol data unit includes a second indication that preemption for low latency data is enabled; and
receive a second acknowledgment in response to the third physical layer protocol data unit, wherein the second acknowledgment includes an indication that the second wireless communication device does not have low latency data.

29. The first wireless communication device of claim 27, wherein the processing system is further configured to cause the first wireless communication device to:
receive, in accordance with the preemption indication, a second physical layer protocol data unit from the second wireless communication device within the transmission opportunity associated with the first wireless communication device.

30. The first wireless communication device of claim 27, wherein the processing system is further configured to cause the first wireless communication device to:
defer a remainder of the transmission opportunity associated with the first wireless communication device to the second wireless communication device in accordance with the preemption indication.
